(19) United States
(12) Patent Application Publication
(10) Pub. No.: US 2026/0249553 A1
(43) Pub. Date: Aug. 27, 2026

(54) Method and apparatus for high-resolution fast layer-by-layer 3D printing

(71) Applicant: Photosynthetic B.V., Amsterdam (NL)

(72) Inventors: Alexander KOSTENKO, Amsterdam (NL); Wesley VAN VLIET, Amsterdam (NL); Mark LAAGLAND, Amsterdam (NL); Aditya NARAYANAN, Amsterdam (NL); Dirk Jan MULDER, Amsterdam (NL)

(21) Appl. No.: 18/853,725

(22) PCT Filed: Apr. 6, 2023
(86) PCT No.: PCT/EP2023/059211

§ 371 Date: Oct. 3, 2024

(30) Foreign Application Priority Data
Apr. 8, 2022 (EP) 22167510.1

(51) Int. Cl. B29C 64/277; B29C 64/135; B33Y 10/00; B33Y 30/00

(52) U.S. Cl. CPC B29C 64/277; B29C 64/135; B33Y 10/00; B33Y 30/00

(57) ABSTRACT

The present invention discloses a photolithography apparatus and method for forming a three-dimensional structure inside a photosensitive material configured to activate photochemical reactions according to a predetermined pattern in a layer inside the photosensitive material. A stage holds the volume of photosensitive material. A light source system produces an excitation beam of a first wavelength and a depletion beam of a second wavelength. A light modulation system forms one or more modulated images using the excitation beam and the depletion beam. An optical system focuses the one or more modulated images in a focal plane positioned inside the three-dimensional volume of photosensitive material. The focused one or more modulated images generate the predetermined pattern comprising one or more excitation regions and one or more depletion regions in the focal plane, selectively activating a photochemical reaction localized to a thin layer of the photosensitive material in the vicinity the focal plane.

### TECHNICAL FIELD

This disclosure generally relates to three-dimensional photolithography. More specifically, but not exclusively, it relates to methods and apparatuses for rapid fabrication of three-dimensional structures within a volume of photosensitive materials or photoresists.

### BACKGROUND

Photopolymerization (also referred as photochemical reaction herein) techniques such as single-photon and multiphoton lithography allow for high-resolution 3D printing using optical beams. Printing relies on photochemical reactions of photosensitive materials, also known as photopolymer, resin, resist, photoresin or photoresist.

Depending on the type, positive or negative, the photopolymer reacts to light and generates or removes cross-linked, solidified polymers respectively. During photopolymerization, a photoinitiator molecule absorbs one or more photons which excites its electron from a ground energy state to an excited energy state, producing a radical. In negative tone photoresists, the produced radicals initiate a chain reaction of polymerization which leads to formation of cross-linked polymer chains, hence curing or solidifying the photoresist. In such a negative tone polymerization process, a volume of liquid photoresist is processed into a solid, cross-linked polymer. Contrarily, in positive tone photoresist, the produced radicals drive a chemical reaction that dissolves the photoresist. In other words, a solid state photoresist is processed to become a soluble liquid. It is noted that the term ‘polymerization’ in this document is used for indicating the photochemical reactions relating to both positive and negative tone photoresists.

Among various photopolymerization techniques, two-photon polymerization (TPP), two-photon lithography (TPL) or two-photon absorption (TPA) is widely used for printing 3D structures at the microscale. The top lateral resolution of TPP is around 100 nanometers. Due to its high resolution and the 3D nature, TPP is emerging as a novel microfabrication technique differentiated from conventional 2D microfabrication techniques such as e-beam lithography. However, TPP requires a large number of photons to be densely focused within a small volume to ensure a sufficient probability of two-photon absorption. In other words, the photon density has to be large enough to ensure two photons can be absorbed by an electron of a molecule within a few femtoseconds (e.g. 10⁻¹⁵-10⁻¹⁴ seconds). This requires a high-power, ultra-short pulse laser which are costly. These lasers usually have a pulse duration of tens of femtoseconds. Since a high number of photons are required to initiate TPP, this technique ensures that the light of the laser is virtually not causing photopolymerization along its beam path except the focal spot where the number of photons is largest. In this way, the polymerization reaction is confined to a sub-micron region in space (i.e. reaction voxel), avoiding any unwanted polymerization elsewhere. Since TPP does not involve any flow or displacement of the printed material, it can be used with both liquid and solid resins or negative and positive tone photoresists and it does not require printing of dedicated supports that stabilize the printed structure.

Even though the focal spot of a TPP printer, where the photochemical reaction is produced, can scan a 3D space with an extremely high linear speed ~500 mm/s the point-by-point nature of TPP still makes the technique inherently slow (e.g. volumetric speed ~0.1-10 mm³/hour). The focal point of the optical beam has to be scanned throughout a layer and move to the next layer.

Hahn et al, “Two-step absorption instead of two-photon absorption in 3D nanoprinting”, Nat. Photon. 15, 932-938 (2021) suggests two-step absorption (TSA) as an alternative photochemical reaction which can overcome the downsides of TPP but can maintain the high resolution feature. More specifically, TSA can reduce the cost on light source systems significantly because it does not require a very strong light intensity as in TPP. In TSA, the first photon absorbed by a radical molecule generates an intermediate state that lasts much longer than that of TPP so that the chance of interaction with a second photon is higher. The second photon may have the same wavelength as the first photon or a different wavelength depending on the type of photoinitator. As in TPP, the number of radicals generated is proportional to I², or I₁*I₂ when using different wavelengths. However, due to the longer duration time of the intermediate energy state, the illumination intensity required for TSA is significantly lower than TPP.

Another 3D printing technique widely used is stereolithography (SLA). SLA is mostly used for printing larger objects that do not require a resolution better than 0.05 millimetre or 50 microns. In SLA, photochemical reaction is initiated via a single-photon absorption of light of ultraviolet (UV) to blue wavelength that is focused at the surface layer of an opaque photopolymer. Rapid absorption of light in the first 10-100 microns of a sufficiently opaque photopolymer ensures confinement of the photochemical reaction to that relatively thin layer without the two-photon absorption effect, enabling layer-by-layer printing. Such process requires relatively low light intensities and allows to achieve printing speeds many orders of magnitude higher than in TPP (e.g. 10⁵-10⁷ mm³/hour) at much lower cost. A modification of SLA based on Digital Light Processing (DLP) or digital micromirror device (DMD) technology, known as DLP printing, can be used for printing 3D object in a layer-by-layer manner instead of point-by-point. Because in SLA/DLP methods the polymerization zone (zone where each layer is generated) is at the surface or at a static depth near the surface of the build volume, each printed layer has to be mechanically moved out of the polymerization zone and displaced with the new resin. This process is limiting the resolution of SLA/DLP. It is also making it impossible to use high viscosity or solid photoresists (i.e., positive tone resists) and is introducing the need for additional support structures required to stabilize the main structure during printing. Minimal printable feature size in SLA or DLP is around 10-50 micrometres which is not suitable for realizing 3D structures at the nano- or microscale.

There are augmentations of the DLP technique (presented below) which exploit photo-inhibition or photo-depletion effect to improve the lateral resolution and to generate a so-called dead zone which prevents polymerization in a layer between the illuminating surface and the polymerization zone, allowing more continuous motion of the newly formed layers away from the polymerization zone while providing the space for the new resin to flow into the polymerization zone.

A modification of the SLA/DLP technique is described in US 2020/001531 A1 that discloses a digital light projector (DLP) system which has first and second light sources. The first optical source generates a first beam at a first wavelength which causes polymerization of a photopolymerizable resist. The second optical source generates a second beam at a second wavelength different from the first wavelength, and where the second beam inhibits polymerization of the photopolymerizable resist. A Digital Micromirror Device (DMD) is included which has a plurality of micromirrors and is configured to be illuminated by the first and second beams to generate a pattern on the micromirrors which has light from the first and second light wavelengths controlled by the micromirror position. The first light image causes polymerization of a first portion of the photopolymerizable resist, while the second image inhibits polymerization of a second portion of the photopolymerizable resist.

This method discloses to increase the lateral XY-resolution of the DLP method by depleting the areas of the printed layer that should stay unpolymerized and, hence, stopping the unwanted polymerization that otherwise happens due to diffusion of radicals in the horizontal XY plane of the printed layer. Further, it is proposed to use the photo absorbers to fine-tune the penetration depth for initiating and inhibiting light which may help reducing the “scalloping” effect—rough edges occurring on the boundary between subsequent printed layers due to the uneven rate of polymerization along Z coordinate (depth).

A modification of the SLA/DLP technique is described in US 2018/015661 A1 that discloses a printing 3D nanostructures arrangement, comprising a first photonic source configured to provide photoinitiation energy to a polymer medium via a dynamic light spatial modulator to an excited state to initiate polymerization, a second photonic source configured to selectively provide inhibition energy to the polymerized medium to a depleted state to inhibit polymerization thereby generating a dead zone below the growth zone, the dead zone allows continuous 3D polymerization. Optionally, a focusing device is used to focus the initiation beam and the inhibition beam at two separate locations along the beam propagation direction, to create the dead zone below the growth zone. Other methods of creating the dead zone include the excitation of an evanescent field or using photo absorbing material which is wavelength dependent.

Another modification of the SLA/DLP technique is described in US 2018/126630 A1 that discloses a method of forming a three-dimensional object comprising: (a) providing a carrier and an optically transparent member having a build surface, the carrier and the build surface defining a build region therebetween; (b) filling the build region with a polymerizable liquid, the polymerizable liquid comprising: (i) a polymerizable component; (ii) upconverting particles that are excited by light at a first wavelength and upon excitation emit light at a second wavelength that is shorter than the first wavelength; and (iii) a photo-initiator that catalyses polymerization of the polymerizable component upon excitation by light at the second wavelength; (c) irradiating the build region through the optically transparent member with an excitation light at the first wavelength, wherein the excitation light is temporally and/or spatially modulated, to thereby form the three-dimensional object from the polymerizable liquid.

In these three methods, the polymerization zone is confined by the dead zone on one side and by the absorption of the initiation beam on the other. While the depth (position) and height (extent) of the polymerization zone can be fine-tuned by adjusting the wavelength-dependent absorption of the resin and the intensity of illumination, the polymerization zone cannot be easily positioned at an arbitrary depth and has to be placed at a static depth near the surface of the build volume. This leads to the fundamental constraints of SLA/DLP methods on printing speed and resolution and compatibility with high viscosity or solid resists.

In these state-of-the-art SLA/DLP methods, photo-inhibition or photo-depletion is only used to address the negative effect of radical diffusion or light diffraction on the XY resolution or to create the dead zone on one side of a static polymerization zone, thereby enabling a more continuous generation of printed layers and allowing to fine tune the height of the polymerization zone.

An alternative 3D printing technique, commonly known as Xolography, is described in DE 10 2019 129868 A1 which discloses a method for processing an optically reactive material, comprising: providing a starting material, which is optically reactive and fills a working volume; and optically processing the starting material in the working volume by means of irradiation of light of a first wavelength and of a second wavelength, wherein the light of the first wavelength and of the second wavelength is provided by a lighting device and at least one material property of the starting material is changed by means of the optical processing and the optical processing comprises the following: irradiating a first partial layer volume of the working volume filled with the starting material using the light of the first wavelength; irradiating the first partial layer volume of the working volume using the light of the second wavelength, wherein the light of the second wavelength is projected into the working volume by means of a projection device capturing only the first partial layer volume wholly or partially.

In this method, each layer is generated in the polymerization zone that is spatially confined via interaction of two perpendicular light beams of different wavelengths. The polymerization zone can now be moved inside the build volume, generating the printed structure layer-by-layer, while keeping that structure static. Newly polymerized layers do not move and do not need to be displaced with the new resin. Nevertheless, the vertical resolution of this method is limited by the minimal thickness of the perpendicular beam (~50-100 microns) which is limited by the diffraction effects occurring due to the large length or area of the beam.

Hence, there is a need to overcome the resolution limit (especially vertical) of the state-of-the-art methods without compromising the speed of printing. A technical challenge in the field is to realize a cost-efficient, high-resolution and high-speed 3D printer, wherein the targeted resolution is preferred to be sub-micrometre.

### SUMMARY

To address the above discussed drawbacks of the prior art, there is proposed, according to a first aspect of the disclosure, a photolithography apparatus for forming a three-dimensional structure inside a three-dimensional volume of photosensitive material configured to activate photochemical reactions according to a predetermined pattern in a layer inside the three-dimensional volume of photosensitive material. The photolithography apparatus may comprise a stage, a light source system, a light modulation system, an optical system and/or an optical system.

The stage may be arranged to hold the volume of photosensitive material. The light source system may be arranged to produce an excitation beam, wherein the excitation beam comprises light of a first wavelength, wherein the photochemical reaction inside the volume of photosensitive material is activated by absorption of light of the first wavelength and further arranged to produce a depletion beam, wherein the depletion beam comprises light of a second wavelength, and wherein the photochemical reaction inside the volume of photosensitive material is deactivated by absorption of light of the second wavelength.

The light modulation system may be arranged to form one or more modulated images using the excitation beam and the depletion beam. The optical system may be arranged to combine the excitation beam and the depletion beam into a combined beam, and further arranged to focus the one or more modulated images of the combined beam in a focal plane positioned inside the three-dimensional volume of photosensitive material.

The optical system may be arranged such as to focus the one or more modulated images to generate the predetermined pattern in such a way that one or more excitation regions and one or more depletion regions are formed inside the three-dimensional volume of photosensitive material, such that the cross-section between the focal plane and the excitation and depletion regions corresponds to the predetermined pattern.

Each excitation region may comprises light of the first wavelength and each of the depletion regions comprises light of the second wavelength. On both sides outside of the focal plane the one or more excitation regions and the one or more depletion regions may at least partially overlap so as to bound a reaction volume inside the photosensitive material centered around the focal plane which is activated by the combined beam.

The lateral and vertical resolution of the obtained reaction volume may be controlled by the light source system and the light modulation system by controlling the amount of overlap of the one or more excitation regions and the one or more depletion regions outside the focal plane.

In an embodiment of the first aspect, the wavelength-dependent absorption of light by the photosensitive material is such that the ratio of the intensities between the excitation beam and the depletion beam throughout the depth of the photosensitive material varies at most by 50%, more preferably 25%, more preferably 10%, most preferably wherein the ratio stays substantially constant.

In an embodiment of the first aspect, the photolithography apparatus is configured to work with photosensitive material having an extinction length such that light of the first and second wavelength can penetrate in the direction of the combined beam throughout the entire three-dimensional volume of photosensitive material, and/or the light of the first wavelength can activate the photochemical reaction at any specific location throughout the entire three-dimensional volume of photosensitive material if the photochemical reaction is not deactivated by the absorption of light of the second wavelength at the specific location.

In an embodiment of the first aspect, the reaction volume is made out of reaction voxels which result from the pattern, and which are each bounded three-dimensionally by one or more depletion regions.

In an embodiment of the first aspect, each excited region is generally bounded by one or more depletion regions.

In an embodiment of the first aspect, the lateral and/or vertical resolution of the reaction volume is controlled by controlling the intensity of the excitation beam and/or the depletion beam.

In an embodiment of the first aspect, the intensity of the excitation and/or depletion beam is varied within the predetermined pattern based on a desired lateral and vertical resolution and size of patterns and/or the amount in which the cross-section of the excitation region with the focus plane is surrounded by the cross-section of the depletion region with the focus plane is based on a desired lateral and vertical resolution, preferably the intensity and/or the amount of being surrounded is varied locally throughout the pattern.

In an embodiment of the first aspect, the excitation beam and the depletion beam are overlapped such that for each excitation region one or more of the depletion regions is formed at a distance equal to the vertical resolution from the focal plane on both sides in the direction of the combined beam.

In an embodiment of the first aspect, the photolithography apparatus is configured such that a first reaction voxel and a second reaction voxel resulting from the same combined beam have different vertical resolutions.

In an embodiment of the first aspect, the one or more modulated images are focused by a lens having a numerical aperture, wherein the lateral resolution and/or vertical resolution of a reaction voxel is controlled by the numerical aperture of the lens, preferably wherein the numerical aperture of the lens is greater than 0.5, more preferably 1.0, more preferably 1.2, more preferably 1.4.

In an embodiment of the first aspect, the light source system is further arranged to produce a second excitation beam comprising light of a third wavelength, wherein the second excitation beam is configured to activate the photochemical reaction jointly with the light of the first wavelength.

In an embodiment of the first aspect, the predetermined pattern is any of a checkerboard pattern, an alternating line pattern, a periodically alternating line pattern, an irregular pattern, a concentric pattern.

In an embodiment of the first aspect, the predetermined pattern is complementarily filled by the one or more excitation regions and the one or more depletion region, preferably wherein the one or more excitation regions and the one or more depletion regions are interleaved.

In an embodiment of the first aspect, the excitation region occupies the cross-section of the focal plane with the three-dimensional structure to be formed for less than 50% in one step.

In an embodiment of the first aspect, the excitation beam and the depletion beam are combined before forming the one or more modulated images or wherein the excitation beam and the depletion beam are combined after forming the one or more modulated images.

In an embodiment of the first aspect, components of at least two of the light source system, the light modulation system and/or the optical system are interleaved along the optical path.

In an embodiment of the first aspect, the photolithography apparatus is configured to form the layer of the three-dimensional structure in the focal plane by activating photochemical reactions according to multiple predetermined patterns subsequently in the photosensitive material, wherein the exposure of the photosensitive material to these multiple predetermined patterns, cumulatively forms the layer, preferably such that the reaction volume resulting from each of the multiple predetermined patterns do not overlap spatially, more preferably wherein the vertical resolution improves the more predetermined patterns are used, more preferably to a predetermined amount by utilizing a particular number of predetermined patterns.

In an embodiment of the first aspect, the vertical resolution of each reaction voxel is controlled by the amount in which each excitation region is surrounded by one or more depletion regions, preferably the periodicity of periodically formed excitation regions.

In an embodiment of the first aspect, the vertical resolution of each reaction voxel is controlled to a predetermined amount by controlling the degree in which each reaction voxel is surrounded in the focal plane by the one or more depletion regions.

In an embodiment of the first aspect, the degree in which each reaction voxel is surrounded in the focal plane by the one or more depletion regions can be controlled by the sparseness of the excitation regions of each of the multiple predetermined patterns and/or the intensity of the excitation and depletion beam.

In an embodiment of the first aspect, the photolithography apparatus switches between the multiple predetermined patterns by using the light modulation system to change the modulated image, by moving at least a part of the optical system, and/or by moving the stage.

In an embodiment of the first aspect, the modulated image is intensity modulated and/or spatially modulated.

In an embodiment of the first aspect, the predetermined pattern comprises a first pattern and a second pattern, the first and second pattern formed by the excitation beam and the depletion beam respectively

In an embodiment of the first aspect, within the one or more excitation regions the photochemical reaction of the photosensitive material is activated, while within the one or more depletion regions the photochemical reaction of the photosensitive material is deactivated such that the photochemical reaction in an out-of-focus region is deactivated.

In an embodiment of the first aspect, absorption of light of the first wavelength by at least part of the photosensitive material activates the photochemical reaction inside the volume of photosensitive material by bringing the at least part of the photosensitive material from a ground state into an excited state and thus producing radicals, while absorption of light of the second wavelength by the photosensitive material deactivates the photochemical reaction inside the volume of photosensitive material by bringing the at least part of the photosensitive material from the excited state back to the ground state, thus depleting radicals.

In an embodiment of the first aspect, the 3D structure formed is at nano-scale, micro-scale, or macro-scale. In an embodiment of the first aspect, the first wavelength is shorter than the second wavelength, preferably between 250-1000 nm. In an embodiment of the first aspect, the photosensitive material is a photoresist or a photopolymer, preferably a photosensitive material that is compatible with stimulated emission depletion (STED) mechanism, photo-induced deactivation (RAPID) mechanism, reverse intersystem crossing (RISC), triplet-triplet annihilation (TTA) or two-step absorption (TSA); preferably wherein when a photochemical reaction activates at a particular position within the volume of photosensitive material, the photosensitive material at that particular position changes from soluble to insoluble or from insoluble to soluble during a subsequent chemical development step.

In an embodiment of the first aspect, a substantial region within the one or more modulated images is focused substantially simultaneously. In an embodiment of the first aspect, the stage is arranged to be moveable in a first and a second direction spanning the focal plane and/or moveable in a third direction orthogonal to the focal plane. In an embodiment of the first aspect, the stage and/or the optical system is arranged to be able to alter the location of the focal plane within the volume of photosensitive material such that the 3D structure can be formed layer-by-layer within each altered location of the focal plane. In an embodiment of the first aspect, the light modulation system comprises a digital micromirror device (DMD), a digital light processing (DLP) chip, a liquid crystal display (LCD), a liquid crystal on silicon (LCOS), a deformable mirror and/or an organic light emitting diode (OLED).

In an embodiment of the first aspect, the light source system comprises a light source, the light source being a light emitting diode, a superluminescent diode, a laser or an arc lamp; preferably wherein the light source system comprises a first light source and a second light source, wherein the first light source produces light of the first wavelength and the second light source produces light of the second wavelength.

In an embodiment of the first aspect, the excitation beam and the depletion beam have respectively a first and second incident angle with respect to the light modulation system, and wherein the light modulation system is configured to use the difference in incident angle to form the modulated image having the predetermined pattern forming a wavelength-modulated image where the one or more excitation and depletion regions are present at the same time. Preferably, the light modulation system comprises a digital micromirror device (DMD) having multiple micromirrors with a first reflection state and a second reflection state and wherein each of the micromirrors in the first reflection state reflects light having the first incident angle towards the three-dimensional volume of photosensitive material and each of the mirrors in the second reflection state reflects light having the second incident angle towards the three-dimensional volume of photosensitive material via the optical system.

In an embodiment of the first aspect, the excitation beam and the depletion beam have the same incident angle with respect to the light modulation system, and wherein the light modulation system is configured to use the difference in wavelength of the light in the excitation beam and the depletion beam to form the modulated image having the predetermined pattern.

Preferably, the light modulation system has modulation elements having a first state and a second state such that light from the excitation beam and the depletion beam is reflected and/or transmitted by the modulation elements in the first state towards the three-dimensional volume of photosensitive material through the periodic color filter, while not reflected and/or transmitted by the modulation elements in the second state towards the three-dimensional volume of photosensitive material.

In an embodiment of the first aspect, the light modulation system is arranged to form a modulated excitation image having a predetermined excitation pattern using the excitation beam and a modulated depletion image having a predetermined depletion pattern using the depletion beam and wherein the modulated image having the predetermined pattern is formed from the modulated excitation image and the modulated depletion image.

Preferably, the light modulation system comprises a first and second digital mirror device, the first digital micromirror device (DMD) arranged to form the modulated excitation image having the predetermined excitation pattern and the second digital micromirror device (DMD) arranged to form the modulated depletion image having the predetermined depletion pattern, and wherein the modulated excitation image and the modulated depletion image are thereafter combined.

In an embodiment of the first aspect, the excitation beam and the depletion beam have the same incident angle with respect to the light modulation system, and wherein the light modulation system is configured to adapt a focal spot of the depletion beam to have a hollow center such that the one or more excitation regions will be surrounded by depletion regions in the focal plane. Preferably, the light modulation system comprises a phase plate, more preferably an annular phase plate or vortex phase plate, and the phase plate is arranged to adapt the focal spot of the depletion beam to have a hollow center. In an embodiment of the first aspect, the predetermined pattern is based on the section of the 3D structure to be formed in the focal plane.

In an embodiment of the first aspect, each of the excitation regions and each of the depletion regions have a predefined area; preferably wherein an excitation region that only falls partially within the boundary of the section of the 3D structure to be formed is exposed during a first exposure period and an excitation region that falls completely within the boundary of the section of the 3D structure to be formed is exposed during a second exposure period, the first exposure period being smaller than the second exposure period.

In an embodiment of the first aspect, an excitation region that only falls partially within the boundary of the section of the 3D structure to be formed is exposed using a first intensity and an excitation region that falls completely within the boundary of the section of the 3D structure to be formed is exposed using a second intensity, the first intensity being less than the second intensity.

In an embodiment of the first aspect, the section of the 3D structure to be formed in the focal plane is formed in multiple exposure steps, wherein at each exposure step only a fractional exposure is delivered, and wherein during and/or after each exposure step the stage is moved in a direction parallel or vertical to the focal plane with a displacement smaller than the voxel size of the predefined area of the excitation region in that direction; preferably wherein the movement of the stage is a continuous movement or a step-by-step movement.

In an embodiment of the first aspect, the excitation beam further comprises light of a third wavelength to activate a photochemical reaction jointly with the light of the first wavelength; preferably wherein the third wavelength can be same or different from the first wavelength.

In an embodiment of the first aspect, the photolithography apparatus is configured to be able to focus the one or more modulated images of the combined beam in a focal plane at arbitrary depth within the three-dimensional volume of photosensitive material.

According to a second aspect of the disclosure, a photolithography method is disclosed for forming a three-dimensional structure inside a three-dimensional volume of photosensitive material configured to activate photochemical reactions according to a predetermined pattern in a layer inside the three-dimensional volume of photosensitive material. The method may comprise at least one of: providing the three-dimensional volume of photosensitive material on a stage; producing an excitation beam, wherein the excitation beam comprises light of a first wavelength, wherein the photochemical reaction inside the volume of photosensitive material may be activated by absorption of light of the first wavelength; producing a depletion beam, wherein the depletion beam comprises light of a second wavelength, and wherein the photochemical reaction inside the volume of photosensitive material may be deactivated by absorption of light of the second wavelength; forming one or more modulated images using the excitation beam and the depletion beam; combining the excitation beam and the depletion beam into a combined beam; focusing the one or more modulated images of the combined beam in a focal plane positioned inside the three-dimensional volume of photosensitive material, such as to generate the predetermined pattern in such a way that one or more excitation regions and one or more depletion regions may be formed inside the three-dimensional volume of photosensitive material, such that the cross-section between the focal plane and the excitation and depletion regions may correspond to the predetermined pattern. Each excitation region may comprise light of the first wavelength and each of the depletion regions comprises light of the second wavelength.

On both sides outside of the focal plane the one or more excitation regions and the one or more depletion regions may at least partially overlap so as to bound a reaction volume inside the photosensitive material centered around the focal plane which is activated by the combined beam. The method may further comprise controlling the lateral and vertical resolution of the obtained reaction volume by controlling the amount of overlap of the one or more excitation regions and the one or more depletion regions outside the focal plane.

In an embodiment of the second aspect, the photosensitive material has the same absorption coefficient for light of the first and second wavelength.

In an embodiment of the second aspect, the photosensitive material has an extinction length such that light of the first and second wavelength can penetrate in the direction of the combined beam throughout the entire three-dimensional volume of photosensitive material, and/or wherein the light of the first wavelength can activate the photochemical reaction at any specific location throughout the entire three-dimensional volume of photosensitive material if the photochemical reaction is not deactivated by the absorption of light of the second wavelength at the specific location.

In an embodiment of the second aspect, the reaction volume is made out of reaction voxels which result from the pattern, and which are each bounded three-dimensionally by one or more depletion regions.

In an embodiment of the second aspect, each excited region is generally bounded by one or more depletion regions.

In an embodiment of the second aspect, the lateral and/or vertical resolution of the reaction volume is controlled by controlling the intensity of the excitation beam and/or the depletion beam.

In an embodiment of the second aspect, the intensity of the excitation and/or depletion beam is varied within the predetermined pattern based on a desired lateral and vertical resolution and size of patterns. In an embodiment of the second aspect, the amount in which the cross-section of the excitation region with the focus plane is surrounded by the cross-section of the depletion region with the focus plane is based on a desired lateral and vertical resolution, preferably wherein the intensity and/or the amount of being surrounded is varied locally throughout the pattern.

In an embodiment of the second aspect, the excitation beam and the depletion beam are overlapped such that for each excitation region one or more of the depletion regions is formed at a distance equal to the vertical resolution from the focal plane on both sides in the direction of the combined beam.

In an embodiment of the second aspect, a first reaction voxel and a second reaction voxel resulting from the same combined beam have different vertical resolutions.

In an embodiment of the second aspect, the one or more modulated images are focused by a lens having a numerical aperture, wherein the lateral resolution and/or vertical resolution of a reaction voxel is controlled by the numerical aperture of the lens, preferably wherein the numeral aperture of the lens is greater than 0.5, preferably 0.8, more preferably 1.0, more preferably 1.2, more preferably 1.4.

In an embodiment of the second aspect, the method further comprises producing a second excitation beam comprising light of a third wavelength, wherein the second excitation beam is configured to activate the photochemical reaction jointly with the light of the first wavelength.

In an embodiment of the second aspect, the predetermined pattern is any of a checkerboard pattern, an alternating line pattern, a periodically alternating line pattern, an irregular pattern, a concentric pattern.

In an embodiment of the second aspect, the predetermined pattern is complementarily filled by the one or more excitation regions and the one or more depletion region, preferably wherein the one or more excitation regions and the one or more depletion regions are interleaved.

In an embodiment of the second aspect, the focusing step comprises focusing the one or more modulated images of the combined beam in a focal plane at arbitrary depth within the three-dimensional volume of photosensitive material.

In an embodiment of the second aspect, within the one or more excitation regions the photochemical reaction of the photosensitive material is activated, while within the one or more depletion regions the photochemical reaction of the photosensitive material is deactivated such that the photochemical reaction in an out-of-focus region is deactivated.

Preferably, absorption of light of the first wavelength by at least part of the photosensitive material activates the photochemical reaction inside the volume of photosensitive material by bringing the at least part of the photosensitive material from a ground state into an excited state and thus producing radicals, while absorption of light of the second wavelength by the photosensitive material deactivates the photochemical reaction inside the volume of photosensitive material by bringing the at least part of the photosensitive material from the excited state back to the ground state, thus depleting radicals.

In a third aspect of the present invention, a 3D structure is disclosed obtained using the photolithography method according to the second aspect of the present invention.

### BRIEF DESCRIPTION OF DRAWINGS

Embodiments will now be described, by way of example only, with reference to the accompanying schematic drawings in which corresponding reference symbols indicate corresponding parts, and in which:

FIGS. 1A-1D show Jablonski diagrams of single-photon and two-photon absorptions and schematic drawings of single-photon and two-photon polymerization. FIG. 1A shows a Jablonski diagram for single-photon absorption. FIG. 1B shows a Jablonski diagram for two-photon absorption. FIG. 1C shows a schematic illustration of single-photon polymerization. FIG. 1D shows a schematic illustration of two-photon polymerization.

FIGS. 2A-2C show the Jablonski diagrams and schematic illustrations of stimulated emission depletion (STED). FIG. 2A shows a Jablonski diagram for STED. FIG. 2B shows a schematic illustration of STED from angled view. FIG. 2C shows a schematic illustration of a cross section of the excitation beam and the depletion beam in the focal plane.

FIG. 3 shows an exemplary embodiment of a photolithography apparatus of the present invention.

FIGS. 4A-4B show a technical challenge which occurs in focusing a 2D pattern in a focal plane positioned inside a three-dimensional volume of photosensitive material. FIG. 4A shows a situation of point-by-point laser scanning in TPP and FIG. 4B shows a situation of simultaneous illumination of a pattern.

FIGS. 5A-5C show a rasterization technique to reduce beam overlapping for multiphoton lithography.

FIGS. 6A-6G show examples of a rasterization of excitation and depletion patterns for excitation-depletion approach. FIGS. 6A-6B show side views or vertical cross-sections of an excitation region generally surrounded by depletion regions. FIGS. 6C-6G show horizontal cross-sections of some examples of rasterized patterns comprising excitation regions (+) and depletion regions (−).

FIGS. 7A-7C show different examples of realizing multi-wavelengths illumination systems based on a light modulation system of the DMD type.

FIGS. 8A-8B show a further embodiment of the embodiment of FIG. 7B, wherein the detail of the intermediate optical element 727 is embodied in further details relating to an annular or a vortex phase-plate.

FIGS. 9A-9C show a rasterization method for the boundary 901 of a layer.

FIGS. 10A-10C show exemplary configurations of movement control of the photosensitive material.

FIGS. 11A-11B show illustrations of the simulated horizontal and vertical resolution profiles of the excitation-depletion technique for the interlaced lines pattern shown in FIG. 6C.

FIGS. 12A-12D show the effect the pattern has on the vertical resolution. FIGS. 12A-12C show three exemplary ways in which to irradiate a particular pattern in one, two or four illuminations respectively. FIG. 12D shows the effect of each irradiation example on the vertical resolution of the obtained product.

The figures are meant for illustrative purposes only, and do not serve as restriction of the scope or the protection as laid down by the claims.

### DESCRIPTION OF EMBODIMENTS

Hereinafter, certain embodiments will be described in further detail. It should be appreciated, however, that these embodiments may not be construed as limiting the scope of protection for the present disclosure.

The invention generally relates to methods and apparatuses for microscale 3D printing using one or more optical patterns using one or more wavelengths of light in combination with photosensitive materials. In particular, the present invention uses two-dimensional (2D) optical patterns to realize a layer-by-layer printing configuration for rapid 3D printing. By confining the optical patterns in a layer at an arbitrary depth and initiating photochemical processes, the invention can rapidly realize a 3D structure by printing 2D layers in a stacked configuration.

Therefore, the present invention proposes a 3D printing device that can have high-resolution but uses a relatively lower power light source system which can lower the cost comparing to the TPP. The examples of lower-cost light source systems include, but are not limited to high-power light-emitting-diodes (LEDs) and long-pulse or continuous wave (CW) lasers. Together with the lower-cost light source systems, it is further desirable to realize a layer-by-layer printing configuration using a predetermined pattern or image which can boost the printing speed significantly compared to TPP. The examples of modulation devices for creating a predetermined pattern or image include, but are not limited to spatial light modulators (SLMs), digital mirror devices (DMDs), liquid crystal display (LCDs), liquid crystal on silicon (LCOSs), organic light emitting diodes (OLEDs) and more.

The invention provides a solution for high-speed, economical, and high-resolution 3D microfabrication using layer-by-layer printing configuration having a sub-micrometre resolution. According to the embodiments of the invention, the sub-micrometre resolution can be achieved through confinement of the polymerization reaction in 3D space via stimulated emission depletion (STED) or similar reactions known as: resolution augmentation through photo-induced deactivation (RAPID), reverse intersystem crossing (RISC), triplet-triplet annihilation (TTA), two-step absorption (TSA), two-photon absorption (TPA) or the combinations thereof.

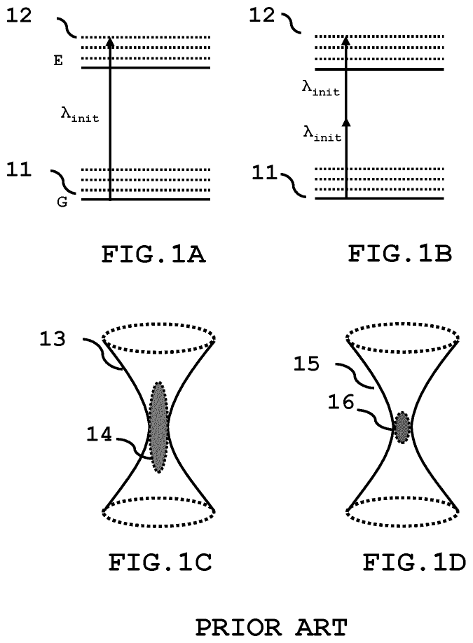

FIGS. 1A-1D show the Jablonski diagrams and schematic illustrations of single-photon and two-photon absorption which lead to corresponding single-photon and two-photon polymerization. The energy states of electrons of molecules have discrete energy states. The transition of from one energy state to another energy state can be initiated by absorbing one or more photons. The total energy of the photon(s) equals the energy difference between the initial state (usually called a ground state) and the excited state.

As shown in FIG. 1A, an electron of a photoinitiator molecule can be excited from a ground state 11 to an excited state 12 by absorbing a single photon with a wavelength of λᵢₙᵢₜ. The energy of the photon absorbed by the electron is hc/λ, wherein h is the Planck constant (1.054571817×10⁻³⁴ J·s) and c is the speed of light (2.99792458×10⁸ meter/second).

FIG. 1B shows a different absorption scheme where two photons are absorbed almost simultaneously (typically within few femtoseconds) for electron excitation, from a ground state 11 to an excited state 12. The energy of one of these photons would not be enough to go from a ground state to an excited state; however, the combined energy of the two photons, 2 hc/λᵢₙᵢₜ, is absorbed to create a radical. It is worthy to note that the relation between the number of radicals and the intensity of light, I, can be different in single- and two-photon cases. In case of single-photon absorption, the number of radicals is linearly proportional to I. In contrast, in two-photon absorption the number of radicals is proportional to I². Due to the requirement of two photons being absorbed almost simultaneously, the two-photon absorption requires a significantly higher number of photons to initiate the polymerization process. Hence a light beam of high peak intensity on the order of 10¹² W/cm², is typically required for TPP processes.

FIG. 1C shows a schematic illustration of single-photon polymerization process. A light beam 13 is focused within a photosensitive material and creates a focal spot where the light intensity I or the number of photons is the largest within the smallest cross-sectional area of the beam. The intensity of light I rapidly diminishes along any direction away from the focal spot. The absorption of photons by the photoinitiator molecules leads to generation of radicals which induce the photochemical reaction at a rate proportional to the light intensity I. The volume where the rate of the photochemical reaction is significant can be called a voxel 14. However, in single-photon polymerization, the voxel may not have a sufficiently sharp boundary. Moreover, focusing multiple beams in the vicinity of each other will lead to severe loss of vertical resolution due overlap between the beams. This prevents the use of single-photon polymerization for 3D printing, unless the polymerization volume is not constrained vertically via additional mechanisms (e.g. high absorption of light in SLA).

FIG. 1D shows a schematic illustration of two-photon polymerization process. Similar to the single-photon polymerization, a light beam 15 is focused and creates a focal spot where the number of photons is the largest. If the light beam 15 has a wavelength that is suitable for two-photon absorption of the radical molecule in the photoresist, the number of radicals produced by this beam is proportional to I² and is extremely small outside the focal spot. As a result, voxel 16 is smaller and has sharper boundaries than the one formed by single-photon polymerization. In this case, vertical resolution does not suffer from sequential exposure of adjacent locations, which enables printing in 3D space.

Depending of the tone of photosensitive material (e.g. photoresist or photopolymer), negative tone or positive tone, a liquid photoresist can be solidified or a solid photoresist can become soluble respectively. The definition of tone is identical in single-photon and two-photon polymerizations.

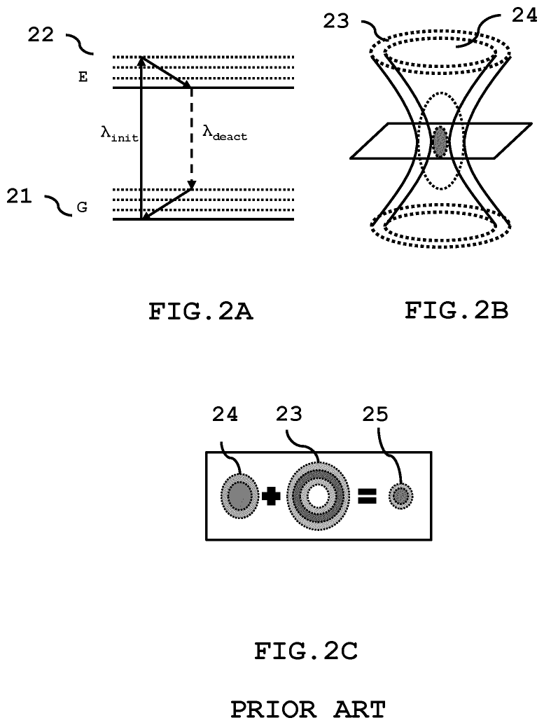

FIGS. 2A-2C show the Jablonski diagrams and schematic illustrations of stimulated emission depletion (STED). This technique is well known in the field of microscopy where high resolution images are realized and is also demonstrated in the field of 2D lithography.

FIG. 2A shows a Jablonski diagram for STED. An excitation wavelength λᵢₙᵢₜ excites an electron from a ground state 21 to an excited state 22. Subsequently the excited electron can produce a radical which initiates a photochemical reaction in a positive tone or a negative tone photoresist. However, if at the same location a deactivating/depleting beam is present comprising of light having a depletion wavelength Δ_{deact}, the deactivating/depleting beam will stimulate an energy transition from the excited state 22 to the ground state 11 in a very short time. Therefore, effectively the electrons are prohibited to stay in the excited states long enough to produce radicals. The production of radicals (and polymerization) can thus substantially only occur where there is no deactivating/depleting beam.

FIG. 2B shows a schematic illustration of STED in angled view. A hollow or donut-shaped focal spot of the depletion beam 23 is aligned or centred with the focal spot of the excitation beam 24. In the region exposed to the depletion beam 23, and the region simultaneously exposed to the depletion beam 23 and the excitation beam 23, there will be no photochemical reaction due to presence of the depletion beam 23. Substantially only in the central region exposed to only the excitation beam 24, the radicals will be produced initiating the photochemical reaction. This way, the polymerization can be prevented in the out-of-focus region of the excitation beam.

FIG. 2C schematically shows the cross sections of the depletion beam 23 and the excitation beam 24. When the two beams are centrally aligned, the centre of the region 25 will only have the excitation beam 24 and rest of the area will be exposed to both the excitation beam 24 and the depletion beam 23 or only by the depletion beam 23. Again, it is noted that only the centre region 25 without the depletion beam will produce radicals which initiate the photochemical reaction. As shown in FIG. 2C, the focal spot of the depletion beam 23 can have a donut-shape. This donut-shaped focal spot of the depletion beam 23, more generally a shape with a hollow centre, may be formed interferometrically by different methods known in the field. For example, such focal spots may be created by placing phase-plates (typically annular or vortex type) or phase modulators in the incident light beam.

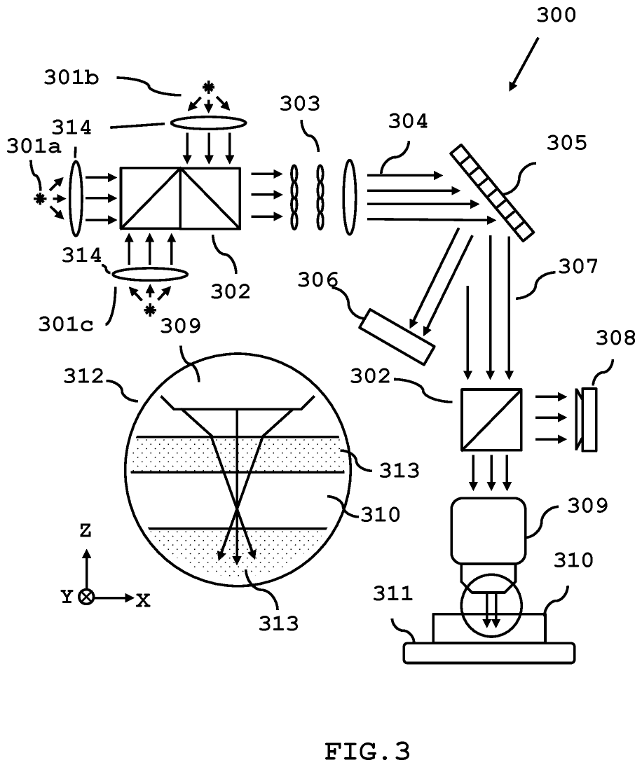

FIG. 3 shows an exemplary embodiment of a photolithography apparatus 300 of the present invention. The photolithography apparatus 300 is configured to print a 2D layer based on a predetermined pattern. The layer-by-layer accumulation of the 2D layers subsequently forms a target 3D structure. Before printing, the target 3D structure is first digitally converted to a set of cross-sections, also referred as a set of layers or a set of slices. The present invention differs from point-by-point TPP configuration at least in that a layer is printed simultaneously (or in a small number of steps) within a photosensitive material based on a predetermined pattern.

A light modulation system 305 is arranged to form one or more modulated intensity images or light patterns using one or more light beams. The modulated intensity image or modulated image comprises or generates the light patterns that form excitation and depletion regions in the focal plane. The light pattern can comprise excitation pixels and depletion pixels, which result in voxels in the focal plane being excited or depleted accordingly. Each excitation pixel and depletion pixel is shaped by the light modulation system 305. The one or more light beams may have same or different wavelengths. If STED technique is used, one light beam may be an excitation beam of the excitation wavelength and another light beam may be a depletion beam of the depletion wavelength of the photosensitive material used. The light modulation system 305 is arranged to generate arbitrary light patterns comprising of for example millions of points or pixels that can be switched on and off over a time-span down to microseconds. Any spatial light modulation technique known in the field can be used. As an example, FIG. 3 shows a schematic of a digital mirror device (DMD) as an exemplary embodiment of the light modulation system 305.

As shown in FIG. 3, a light source system 301a-c is arranged to produce one or more light beams at one or more wavelengths. The light source system 301a-c can be any known optical device that generates a light beam such as a laser, superluminescent diode, arc lamp or a light emitting diode (LED). Preferably, the one or more light beams are shaped into an even, flat wavefront (or a Gaussian-shape) with a controlled numerical aperture. This can be done for example using a collimating lens 314 followed by ‘fly eye’ microlens arrays and a field lens 303. In the case of using a coherent light source like a laser, diffraction elements can also be used for shaping the beam with a desired shape. The shaped light beam 304 is then incident on a light modulation system 305, in this embodiment exemplified with a DMD matrix 305. The DMD matrix 305 then forms one or more modulated images using the one or more light beams generated by the light source system 301a-c at one or more wavelengths. The unwanted portion of the shaped light beam 304 is reflected by the off-state mirrors (pixels) of the DMD matrix 305 and is directed into a beam stop 306. The one or more modulated images formed by the light modulation system 305 is reflected to an optical system 309 arranged to focus the one or more modulated images in a focal plane positioned inside a three-dimensional volume of a photosensitive material 310 which is also referred as photosensitive material. The optical system 309 may de-magnify the one or more modulated images and increase the resolution and numerical aperture according to the need of the printing session. Each pixel of the DMD matrix 305 produces a light beam that is focused inside the photosensitive material 310 after propagating through the optical system 309. The position of the focal plane on which all beams are focused can be changed by controlling the relative position between the photosensitive material and the focused one or more modulated images. The relative position can be changed by three-dimensional movement of XYZ-translational stages 311 that is holding the volume of photosensitive material 310. Another possibility of changing the relative position between the focused one or more modulated images and the photosensitive material 310 is the axial movement of the optical system 309. By axial movement in this context, it means the movement along the direction that the beams are propagating. The relative position can also be controlled by using dynamically adjustable adaptive optics such as deformable mirrors or liquid crystal on silicon (LCOS) spatial light modulators. The control of the relative position is relevant also in the contexts of super-resolution effects and aberration control.

The optical system can be arranged to combine the excitation beam and the depletion beam into a combined beam, and to focus the one or more modulated images of the combined beam in a focal plane positioned inside the three-dimensional volume of photosensitive material. The combination of the excitation beam and the depletion beam can happen before or after the light modulation system. The optical system may have components which are positioned before and/or after certain components of the light modulation system along the optical path.

The circle located around the photosensitive material 310 is zoomed in as a zoomed-in view 312. In this embodiment the photosensitive material 310 is sandwiched between two cover glasses 313 located on the XYZ-translational stages 311. It is worthy of note that the present invention is not limited to this particular configuration of the photosensitive material 310 relative to the optical system 309. Various configurations are standardized in the field of 3D photolithography. The examples of configurations are, along the light beam path: (i) objective lens-air-cover glass-photosensitive material, (ii) objective lens-air-photosensitive material, (iii) objective lens-immersion medium-cover glass-photosensitive material, (iv) objective lens-immersion medium-photosensitive material, and (v) objective lens-photosensitive material (also known as Dip-In configuration).

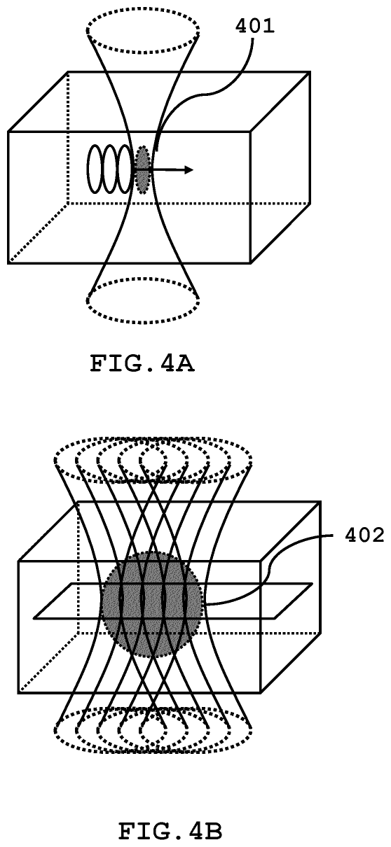

FIGS. 4A-B show a technical challenge which occurs in focusing a 2D pattern in a focal plane positioned inside a three-dimensional volume of photosensitive material. FIG. 4A shows a situation of point-by-point laser scanning for example conventional scanning-based TPP lithography. In this point-by-point configuration, the photochemical reaction is always confined within a single focal spot of the beam. In contrast, FIG. 4B shows a situation of simultaneous illumination of a pattern. In this configuration, a 2D pattern is simultaneously projected onto a focal plane by a light modulation system such as a DMD. Due to the overlapping of the beam paths of each beam from different pixels of the DMD, the volume of photochemical reaction can be expanded as opposed to a predetermined pattern, hence losing the spatial resolution defined in the predetermined pattern.

In multiphoton lithography such as classical TPP or other multi-step absorption processes, the radial production rate is proportional to I² (or Iⁿ, n>1) for single wavelength process, or in case of multi-wavelengths I₁*I₂ (for n=2). Hence, the number of unwanted radicals produced in the out-of-focus region by a scanning beam in point-by-point regime is proportional to the sum of squares of beam intensity ΣI² over the number of beam positions and in simultaneous pattern projection regime, to the square of the sum of beam intensities (ΣI)² over the number of beams. The latter being significantly larger.

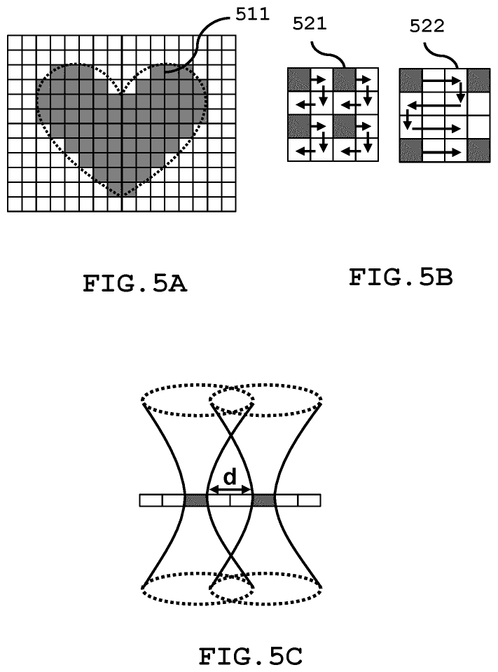

FIGS. 5A-C illustrate a rasterization technique that can be used to reduce beam overlapping effects in simultaneous projection regime when TPP or other multi-step process are employed.

The term “rasterization” is used in this disclosure to indicate converting an image or a spatially modulated planar region into pixels. For example, an image can be rasterized into arrays of pixels and be projected or focused on a focal plane. The image can be a predetermined pattern used in the present invention. The image is formed by the spatially modulated excitation beam. Thanks to the spatial modulation, the excitation beam can be seen as a collection of sub-beams associated with individual pixels. Each sub-beam reaches its minimum radius (beam waist) and highest intensity in the focal plane, while expanding and decreasing intensity as the distance from the focal plane increases. Thanks to that effect, sub-beams associated with individual pixels have little to no overlap in the focal plane but may overlap when the distance from the focal plane increases. The rate at which sub-beams expand depends on the angular aperture or the numerical aperture (NA) of the optical system. Adjacent beams overlap at shorter distances in optical systems with a higher NA.

The term “voxel” is a 3D equivalent of a pixel. Excitation or reaction voxel indicates the smallest unit that can be polymerized in a lithography apparatus. The smallest size of an individual reaction voxel in a single-photon polymerization is determined by the diffraction limit and according to Abbe's formula is

$$∼ \frac{2 λ}{N {A}^{2}}$$

in the vertical direction (Z) and

$$∼ \frac{λ}{2 N A}$$

in the lateral direction (XY). This would, for instance, lead to a vertical resolution of 0.4 micrometres and a lateral resolution of 0.13 micrometres for the wavelength of 400 nm with a numerical aperture of 1.4. The resolution of two-photon or two-step polymerization is slightly more complex, however, it is still proportional to the wavelength λ and inverse-proportional to the NA, making low wavelengths (<600 nm) and high-NA optics (NA>0.5) preferrable.

FIG. 5A shows a cross-section, or a top view of a layer 511 of a 3D structure to be rasterized. In this example, the layer is a heart shape. The region that needs to be polymerized in shown as filled pixels 511. Simultaneous illumination of all voxels to the filled pixels 511 will result in the overlapping problem depicted in FIG. 4A-B even when a two-photon or two-step polymerization is exploited. Therefore, the illumination of the layer is divided into k steps each comprising different patterns. As shown in FIG. 5B, in each pattern, the closest voxels are separated by a minimum distance. In case of the first pattern 521, the closest voxels have a minimum distance of one voxel (edge-to-edge distance). In order to fill the entire area of the first patter 521, the pattern has to be printed in 4 steps (k=4) as indicated by the arrows in FIG. 5B. Similarly, for the second pattern 522, the closest voxels have a minimum distance of two voxels, therefore, the pattern has to be printed in 9 steps (k=9). The minimum distance d is indicated in FIG. 5C. In the shown rectangular rasterization example, the relationship between k and d is k=(d+1) 2, wherein d is the number of empty voxels between the closest illuminated voxels. Assuming that all voxels of the layer need to be exposed and that one out of k voxels is exposed during each step, the intensity of out-of-focus light will be proportional to 1/k and the number of unwanted radicals generated by each step is ~1/k². Hence, after k steps, the number of unwanted radicals is ~k/k² or ~1/k, or 1/(d+1)². The parameters k and d can be adjusted layer-by-layer, depending on the number of unwanted radicals that can be tolerated by the target 3D structure. Even though the examples in FIG. 5B are shown as periodic, it is worthy of note that the pattern can be arbitrary in shape, only characterized by the minimum distance between the closest illuminated voxels.

As discussed earlier, depletion-based methods such as STED and RAPID can be used to avoid the problem of overlapping beams when many pixels are illuminated simultaneously, hence, they can be used for achieving high resolution while not necessarily using multiphoton absorption. These methods allow to further increase the speed of printing and lower the capital cost by enabling 3D printing based on single-photon absorption and, hence, requiring substantially lower light intensities. The depletion-based methods can spatially confine the production of radicals to a single layer via simultaneous projection of excitation and depletion illumination patterns wherein the out-of-focus regions of the excitation beams are deactivated by the overlapping out-of-focus depletion beams. The processes of excitation and depletion may be both based on a single-photon absorption or on multi-photon absorption.

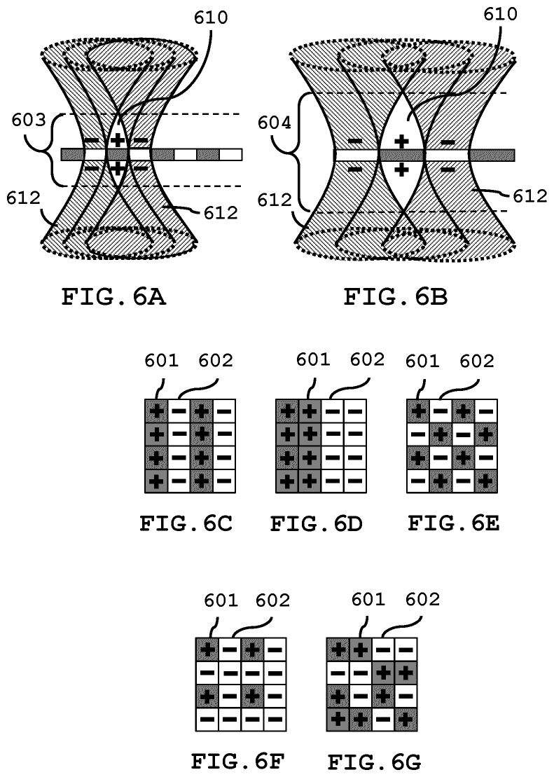

FIGS. 6A-6G show examples of a rasterization of excitation and depletion patterns for depletion-based techniques. FIGS. 6A-6B show side views through a focal plane with an excitation pixel (+) generally surrounded by depletion pixels (−). FIGS. 6C-6G show top views of some examples of patterns comprising excitation pixels and depletion pixels (−).

FIG. 6A shows a side view of a predetermined pattern and a reaction voxel 610 corresponding to one of the excitation pixels 601 generally surrounded by depletion pixels 602 associated with depletion regions 612. From left to right, the predetermined pattern is an alternating pattern of excitation and depletion pixels. As shown, the depletion region 612 overlaps with the excitation region. However, around the centre of the excitation region, there is a reaction voxel 610 where the depletion region is not present or present with an insignificant amount. A reaction voxel 610 denotes the three-dimensional region in the photosensitive material where the photochemical reaction can occur, whereas the reaction is inhibited outside the reaction voxels 610, where depletion is occurring. The height 603 of the reaction voxel is known as the vertical resolution or feature size, the smallest size that can be polymerized in the vertical direction which is in the beam direction (also known as a beam axis or an optical axis).

FIG. 6B shows a side view of a predetermined pattern where the excitation regions and the depletion regions are alternating more coarsely (see FIG. 6D) than in the predetermined pattern shown in FIG. 6A. The reaction voxel 610 is spatially less confined in the vertical direction in FIG. 6B, yielding lower vertical resolution 604. The pixels are illuminated alternatingly between the excitation wavelength 601 and the depletion wavelength 602. After a sufficient exposure time, when the voxels designated with the excitation pixels are polymerized, the pattern can be inverted so that the entire area can be polymerized without over-polymerizing any unwanted regions in and out of the focal plane if so desired. The present invention is not limited by the alternating pattern shown in FIG. 6C-6G.

The excitation voxels can be completely surrounded by the depletion voxels that is one excitation voxels is surrounded by nine depletion voxels, or any other number as desired. However, in that case, a higher number of steps will be required to expose all of the voxels of the printed layer. The number of neighbouring excitation voxels can also be designed depending on the preferred resolution and speed.

The shape of the reaction voxels 610, especially the vertical length or vertical resolution, can be controlled by various factors such as the pixel size and the numerical aperture (NA) of the optical system. Not taking into account the depletion process, the smallest voxel size or resolution achievable in the single-photon process due to the diffraction limit will be proportional to

$$\frac{2 λ}{N {A}^{2}}$$

in the vertical direction (Z) and to

$$\frac{λ}{2 N A}$$

in the lateral direction (XY). The resolution of the system that utilises depletion beams of the type depicted in FIG. 2B is comparable to the rasterized case in FIG. 6F and can be computed and is proportional to

$$\frac{2 λ}{N {A}^{2} ( 1 + σ )}$$

in the vertical direction (Z) and to

$$\frac{λ}{2 N A \sqrt{1 + σ}}$$

in the lateral direction (XY), where σ is a so-called saturation factor proportional to the depletion intensity.

Zhenlong Wang et al. “STED Direct Laser Writing of 45 nm Width Nanowire”, Micromachines, 10 (11), 2019 report a point-by-point STED-based lithography method whereby using a donut-shaped depletion beam a lateral (XY) resolution was improved from 120 nm to 45 nm in single-beam, two-dimensional lithography. The inventors of the present invention have realized that this 2.6-fold improvement in the lateral direction should translate to 7-fold improvement in the axial or vertical direction when the herein proposed three-dimensional lithographic printing method is used. Hence, a similar DMD-based system would be able to reach 45 nm lateral resolution and 60 nm vertical resolution surpassing any of the existing 3D printing methods.

FIGS. 6C-6G show top views of some examples of patterns comprising excitation pixels (+) and depletion pixels (−). For example, FIG. 6C shows an alternating line pattern. The period size of the periodic pattern determines the vertical resolution of the resulting excitation region. FIG. 6D shows a pattern where two lines of pixels are excitation pixels, and two lines of pixels are depletion pixels. The vertical resolution associated with the resulting excitation voxels will be lower for the pattern depicted in FIG. 6D than for the pattern depicted in FIG. 6C because of the larger excitation voxel size. FIG. 6E shows a checkerboard pattern. The pattern shown in FIG. 6F is a pattern where the excitation pixels are spread out further and surrounded even more by depletion pixels. This may result in a better vertical resolution than the result of FIG. 6E which has better vertical resolution than the pattern on FIG. 6C. Of course, one is not bound by periodic patterns, or structured pattern design but irregular patterns like shown in FIG. 6F can also be used depending on the design to be obtained. Varying vertical resolution can thus be obtained within the same printed layer by making certain regions denser in terms of the number of excitation pixels than others. Concentric pattern designs are also possible.

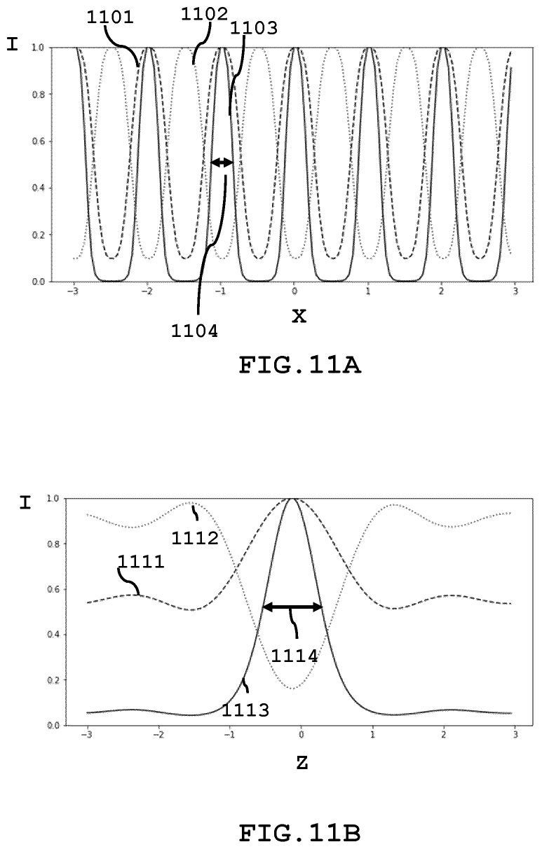

FIGS. 11A-11B show illustrations of the simulated horizontal and vertical resolution profiles of the excitation-depletion technique for the interlaced lines pattern shown in FIG. 6C. The simulation was performed with a pattern line pitch of 1 micrometre, a light beam with wavelength 460 nanometre, and a numerical aperture of 1.0. The line pattern is periodic in the X direction, and the lines are formed along the Y direction.

FIG. 11A shows the obtained horizontal cross-section in the focal plane of the resolution profile. The horizontal axis shows the position in the X direction in micrometre. The vertical axis shows the illumination intensity in arbitrary units corresponding to the normalized excitation intensity 1101 (dashed line) or the normalized depletion intensity 1102 (dotted line) and the resulting radical production rate in arbitrary units (solid line). As can be clearly seen, the depletion beam inhibits the reaction of the photosensitive material to the initiation beam.

Arrow 1104 depicts the horizontal resolution, i.e., the smallest lateral feature size. Note that the size of the individual reaction zone (single line width) can be smaller than the illuminated excitation zone due to the overlap with the adjacent depletion zones in the horizontal direction. The overlap is due to the diffraction limit (or other sources of resolution loss).

FIG. 11B shows the vertical cross section through one of the illuminated lines. The horizontal axis shows the position in the Z direction in micrometres. The vertical axis shows the illumination intensity and the radical production rate in arbitrary units. The dashed line denoted with reference numeral 1111 shows the normalized excitation intensity, while the dotted line denoted with reference numeral 1112 shows the normalized depletion intensity. The solid line denoted with reference numeral 1113 shows the normalized reaction rate of the photosensitive material. Again, the depletion beam inhibits the reaction of the photosensitive material to the excitation beam.

Arrow 1114 depicts the vertical resolution, i.e., the smallest feature size. This is the width of the reaction zone in the vertical direction. Note that in this example the combined excitation intensity of the simultaneously illuminated line pattern only drops by 50% and stays relatively constant away from the focal plane (light spreads evenly when the lines defocus) while the combined depletion intensity reaches its maximum. The intensity used for the depletion light has to be sufficient to stop the reaction caused by the unwanted excitation light. Increasing the depletion intensity will lead to further “shrinking” of each individual polymerization zone in the vertical direction and the horizontal direction perpendicular to the interlaced lines.

By engineering the pattern comprising one or more excitation regions and one or more depletion regions, it is possible to control the vertical resolution which is the depth of the photochemical reaction in the vertical direction (optical axis, beam direction, or direction of illumination). The depth can also be defined by the vertical size of each excitation voxel created by projecting an excitation pixel.

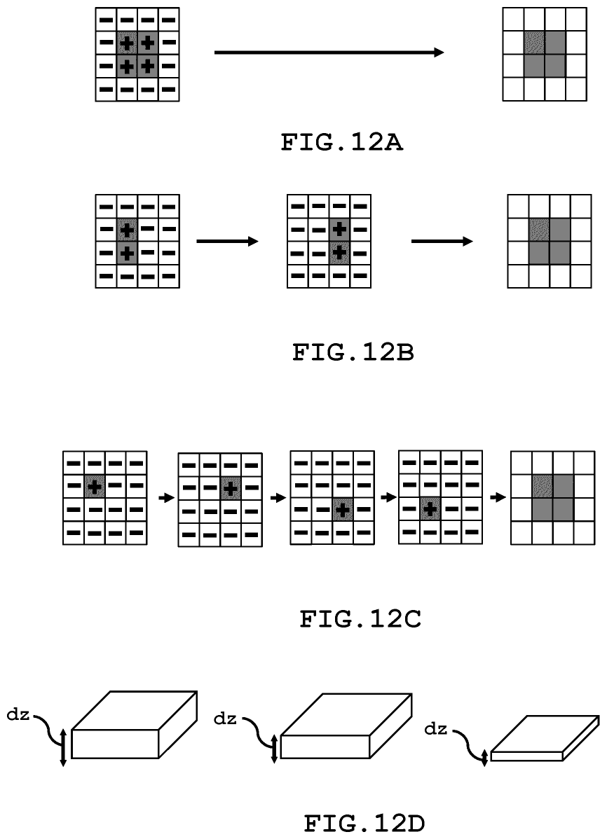

FIGS. 12A-12D show the effect the pattern has on the vertical resolution and speed of printing. FIGS. 12A-12C show three exemplary ways in which to irradiate a particular product layer structure in one, two or four illuminations respectively. FIG. 12D shows the effect of each irradiation example on the vertical resolution of the obtained product layer structure. In all three exemplary ways, the structure to be obtained is a square-shaped structure in a particular product layer.

In the exemplary method shown in FIG. 12A, the structure is obtained in a single illumination, wherein the cross-section of the excitation region with the focal plane covers substantially the entire horizontal area in the focal plane where the structure needs to be formed. The excitation region is surrounded on all sides in the focus plane by an inhibition region. The resultant smallest vertical feature size dz one can obtain with this first exemplary method is shown in the leftmost drawing of FIG. 12D.

In the exemplary method shown in FIG. 12B, the structure is obtained in two illumination rounds, wherein the cross-section of the excitation region with the focal plane covers substantially half the horizontal area in the focal plane where the structure needs to be formed. Again, each time the excitation region is surrounded on all sides in the focus plane by an inhibition region. After doing the first exposure, the pattern is changed (either by physically moving the photosensitive material or the lens, or by changing the modulation resulting from the light modulation system for example by switching the mirrors in a DMD from the first state to a second state) and the second exposure is performed. After the two exposures, the cross-section of the two excitation regions (from the first and second exposure) with the focal plane covers substantially the entire horizontal area in the focal plane where the structure needs to be formed. The resultant smallest feature size dz one can obtain with this second exemplary method is shown in the middle drawing of FIG. 12D. Since during the first and second exposure the excitation region is more bounded by the depletion region below and above the focal plane—the excitation region in the focus plane is smaller as explained above—the resultant smallest feature size is smaller and the printing speed is lower than obtained using the first exemplary method.

In the exemplary method shown in FIG. 12C, the structure is obtained in four illumination rounds, wherein the cross-section of the excitation region with the focal plane covers substantially a quarter of the horizontal area in the focal plane where the structure needs to be formed. Again, during each exposure the excitation region is surrounded on all sides in the focus plane by an inhibition region. After doing the first exposure, the pattern is changed (in the same way as above) and the second, third and fourth exposure are subsequently performed. After these four exposures, the cross-section of the four excitation regions (from the first to fourth exposures) with the focal plane covers substantially the entire horizontal area in the focal plane where the structure needs to be formed. The resultant smallest feature size dz one can obtain with this second exemplary method is shown in the middle drawing of FIG. 12D. Since during each separate exposure the excitation region can be more bounded by the inhibition region below and above the focal plane—again since the excitation region in the focus plane for each separate exposure is smaller as explained above—the resultant smallest feature size is smaller and the printing speed is lower than obtained using the first and second exemplary method.

In general, using the invention one can control the vertical resolution of a particular layer structure by utilizing a particular number of predetermined patterns to initiate a reaction in the photosensitive material. This can be done in such a way that the excitation regions resulting from each of the multiple predetermined patterns cumulatively forms the layer structure. The greater the number of predetermined patterns used, the more freedom one has to surround the one or more excitation regions more closely with depletion regions. By more closely surrounding the excitation regions in this manner, the resulting reaction voxels will be spatially bounded more stringently in the vertical direction. If one uses a predetermined amount of periodic patterns, it is thus the periodicity size of each of the patterns which determines the vertical resolution.

More generally, the sparseness of the excitation regions of each of the predetermined patterns determines the degree in which each reaction voxel is spatially bounded by the one or more depletion regions and this sparseness can be controlled by the degree in which each reaction voxel is surrounded in the focal plane by the one or more depletion regions.

Additionally, the degree in which each reaction voxel is surrounded in the focal plane by the one or more depletion regions can be controlled by the intensity of the excitation and depletion beams. For example, an excitation beam with a strong intensity will be more difficult to inhibit by a depletion beam with a weak intensity.

An example of photosensitive material which may be used for the above-described depletion-based technique can be found in Y. Xu et al., “Radical Photopolymerization Using 1,4-Dihydropyrrolo[3,2-b]pyrrole Derivatives Prepared via One-Pot Synthesis”, ACS Omega 2021 6 (32), 20902 (2011).

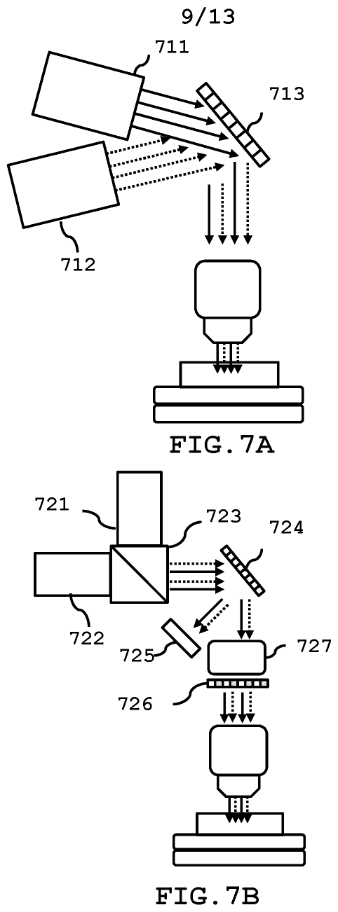

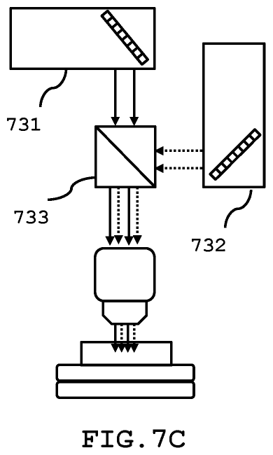

FIGS. 7A-7C show different examples of realizing multi-wavelengths illumination systems based on a light modulation system. The illumination systems are arranged to form one or more modulated images in a focal plane positioned inside the three-dimensional volume of photosensitive material, wherein the focused one or more modulated images can generate a predetermined pattern comprising one or more excitation regions and one or more depletion regions in the focal plane, wherein each excitation region comprises light of a first wavelength and each of the depletion regions comprises light of a second wavelength. The excitation region at each point in time is configured to initiate the photochemical reaction within the boundary of the printed layer.

A light modulation system can comprise but is not limited to spatial light modulators (SLMs), digital mirror devices (DMDs), liquid crystal display (LCDs), liquid crystal on silicon (LCOSs) and/or organic light emitting diodes (OLEDs). In this embodiment, however, DMD is used as a representative example. In general, commercial RGB projectors based on DMDs are not configured to emit various wavelengths simultaneously. Instead, it quickly switches between three wavelengths (red, green, blue) and appears to human eyes as presenting multiple colors at the same time, which is not technically correct and suitable for depletion-based techniques. Typically for a depletion-based technique like STED, the photoinitiator molecules have to be deactivated within nanoseconds to microseconds for the photosensitive material to be effectively depleted.

FIG. 7A shows an embodiment of a two-wavelengths illumination system using the on- and off-state of the micromirrors of a DMD. In regular use, arrays of micromirrors in a DMD are designed to reflect the incident light at two angles, one in the direction of the optical system for continuation of optical processes (on-state) and another one in the direction of a beam stop (off-state). By reversing the process, a DMD can reflect, two incident beams coming from different angles into a same direction.

The light beams are then fed to the optical system and are focused to form respective patterns within a photosensitive material. When the two angles are used by an excitation beam and a depletion beam respectively, a modulated image for excitation is formed by one of the on- and off-state of the micromirrors and a modulated image for depletion is formed by the remaining state of the micromirrors. The excitation beam can use light for example between 350 nm and 600 nm (depends on the initiator), while the depletion beam can use light between 450 nm and 800 nm. Usually, the depletion light is shifted to red compared with the excitation light.

In this configuration, it is not necessary to use a beam stop. This configuration for illumination can be used combinedly with the multi-step rasterization described in FIG. 6A-6B to avoid unwanted photochemical reactions in and out of the focal plane. For example, for printing a connected area, 50% of the pixels can be used for excitation while the remaining 50% of the pixels are used for depletion. By switching the state between on- and off-states of the micromirrors, the area can be printed (filled) without having unwanted photochemical reactions. The switching of the excitation and depletion regions can also be done by lateral movement of the photosensitive material or the illumination system. Using XYZ-translational stages, one can move the photosensitive material in the lateral direction, perpendicular to the optical axis to ensure every target voxel undergo photochemical reaction. It may be preferred in some cases to have a moving illumination system and stationary stage with the photosensitive material. In case of using XYZ-translational stages, the boundary of the printed area has to be dynamically adjusted according to the boundary of the predetermined pattern for the layer.

FIG. 7B shows an embodiment of a two-wavelengths illumination system wherein the light from the excitation light source 721 and an depletion light source 722 may be combined by a beam splitter or a dichroic mirror 723 in that both excitation and depletion wavelengths are simultaneously projected by the on-sate of the DMD pixels 724 or stopped by a beam stop 725 in off-state. In this configuration, the DMD pixels 724 can contain an image of the entire layer to be printed. Application of a periodic excitation-depletion pattern using one or more patterns can be carried out by a second DMD pixels or a periodic color filter 726 positioned after an intermediate optical element 727.

The periodic modulation of wavelength on the DMD can also be formed by the optics positioned before the DMD instead of a periodic colour-filter after the DMD.

FIG. 7C shows an embodiment of a two-wavelengths illumination system wherein two DMD chips 731, 732 are each coupled to a separate light source system. One light source system operates at the excitation wavelength and the other light source system operates at the depletion wavelength. The modulated image for excitation formed by the first DMD chip 731 and the modulated image for depletion formed by the second DMD chip 732 are combined via a beam splitter or dichroic mirror 733 and fed to the optical system for the remaining lithography processes. This configuration allows for separate projection of excitation and depletion patterns in arbitrary shapes.

The absorption of light of the first wavelength by the photoinitiator or photosensitizer molecules activates the photochemical reaction inside the volume of photosensitive material by bringing the molecules from a ground state into an excited state and thus producing chemically reactive species, while absorption of light of the second wavelength by the photosensitive material deactivates the photochemical reaction inside the volume of photosensitive material by bringing the molecules from the excited state back to the ground state, thus depleting chemically reactive species.

Photosensitive material may consist of a mixture of monomers, oligomers, photoinitiators, co-initiators, photosensitisers, inhibitors etc. Typically, the initiators, sensitisers and co-initiators become excited as a result of photoexcitation, initiating the photochemical reaction.

Photo-initiation mechanisms may include: Norrish Type I photo-initiators that directly initiate free-radical polymerization; Norrish Type II photo-initiators which can be combined with a co-initiator and were shown to be highly effective with various types of two-step polymerization reactions and excitation-depletion reactions (both single wavelength and multi-wavelength); cationic initiators or photo acid generators (PAGs), including diaryliodonium and triphenylsulfonium salts. PAGs can be used in charge transfer complexes (CTCs) in order to extend the range of light wavelengths which can be utilized for photoinitiation. PAGs can also be used to both initiate polymerization and dissolve polymers, hence, they enable making both negative tone and positive tone photoresists.

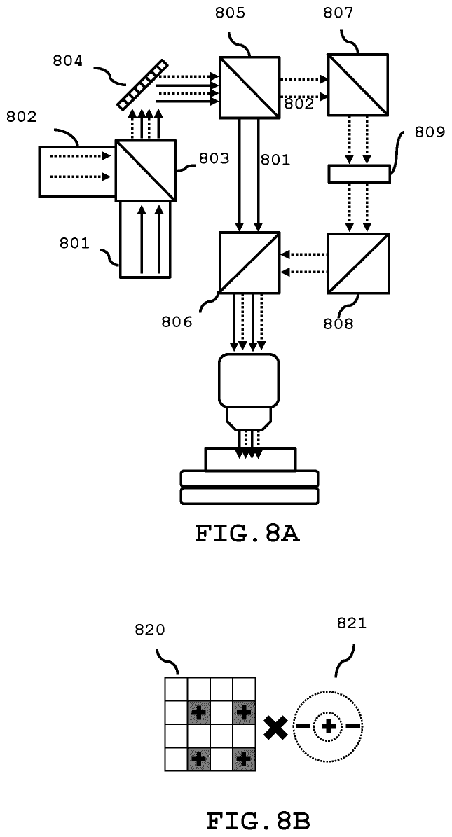

FIGS. 8A-8B show a further embodiment of the embodiment of FIG. 7B, wherein the detail of the intermediate optical element 727 is embodied in further detail relating to an annular or a vortex phase-plate. An excitation beam 801 and a depletion beam 802 are combined by a beam splitter or a dichroic mirror 803 before being reflected by a DMD 804. After passing through the DMD 804, the excitation beam 801 and the depletion beam 802 have a same pattern 820 as shown in FIG. 8B, where each excitation voxel or focal spot is surrounded by a donut-shaped depletion focal spot. After reflecting from the DMD 804, the excitation beam 801 and the depletion beam 802 are spatially divided and directed into two beam paths respectively by a second beam splitter or dichroic mirror 805. The two beams are recombined by a third beam splitter or dichroic mirror 806 after the depletion beam 802 propagating through a phase-plate 809 or any other intermediate optical element that can create a annular or a vortex phase front of a beam 821. Along the path, the depletion beam 802 is re-directed by mirrors 807, 808 to the third beam splitter or dichroic mirror 806 and recombines with the excitation beam 801. The excitation beam 801 and the depletion beam 802 are then combined and fed into an optical system. As described earlier, the excitation beam 801 and the depletion beam 802 have a same pattern after reflecting from the DMD 804. However, due to the additional modulation of the depletion beam by a phase-plate 809, the depletion beam will have a donut-shape focal spot 821 when focused as shown in FIG. 8B. The optical system can then be arranged to focus the modulated images in a focal plan positioned inside the three-dimensional volume of photosensitive material, wherein the focused modulated images generate the predetermined pattern comprising one or more excitation regions and one or more depletion regions in the focal plane, wherein each excitation region comprises light of the excitation wavelength and each of the depletion regions comprises light of the depletion wavelength.

Instead of the phase-plate 809, a second separate modulator such as a deformable mirror or LCOS can be used to form the hollow beam and further correct for optical aberrations. Preferably, every excitation voxel will be surrounded by depletion light when it is focused inside the photosensitive material to avoid unwanted photochemical reaction in and out of the focal plane. It is noted that the light modulation system can be any known modulation device known in the field of light modulation.

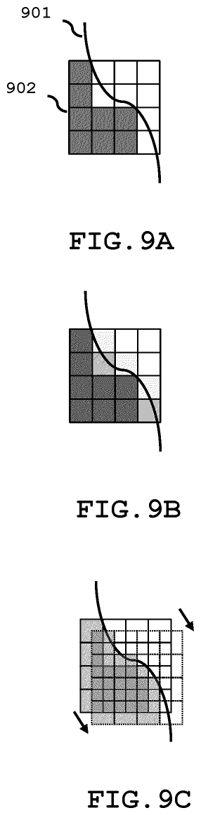

FIGS. 9A-9C show a rasterization method for the boundary 901 of a layer. FIG. 9A shows a general configuration where all voxels within a target region 902 are exposed with a same optical power of the light beam. FIG. 9B shows a preferred configuration where the voxels traversed by the boundary 901 is partially exposed relative to the full exposed voxels as in FIG. 9A. The adjustment of the exposure is carried out by adjusting the time of the on-state of the corresponding individual pixels in the excitation pattern accordingly. In a more preferred configuration, the layer is printed in multiple steps, where at each step all relevant voxels are partially exposed while the complete exposure is achieved by a sub-voxel movement of the photosensitive material as shown in FIG. 9C. This configuration helps to realize a smoother boundary than the earlier configuration relating to FIG. 9A and FIG. 9B. The sub-voxel movement of the photosensitive material can be carried out in a step-by-step motion or a continuous motion by XYZ-translational stages.

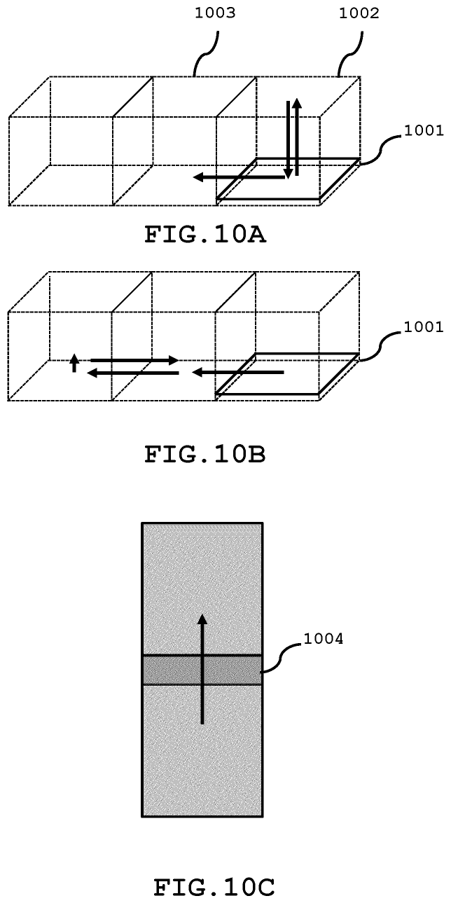

FIGS. 10A-10C show exemplary configurations of movement control of the photosensitive material.

The photosensitive material can be mounted on a stack of high-precision XYZ-translational stages. Alternatively, the illumination system may be mounted on a translation stage along one or more dimensions instead. The translation in Z direction is used to adjust the depth of the focal plane created by the optical system of a photolithography apparatus during layer-by-layer printing. The Z direction movement can also be done by controlling the Z-position of the optical system by for example a height-adjustable microscope. X and Y direction movements can move the photosensitive material horizontally in the plane perpendicular to the axis of the light beam. The X and Y direction movements allow for printing an area that is larger than the maximal illumination area by stitching or tiling the illuminated patterns. Movement in any direction can be either a step-by-step movement or a continuous movement. Since the movement of the photosensitive material is effectively moving the relative position of the focal plane comprising the focused modulated images, the movement can be depicted indirectly by the changes in position of the focused modulated images.

FIG. 10A shows a printing configuration where a focused modulated image 1001 first moves vertically to print all layers of a first block 1002, completing the photochemical reactions designated to the volume occupied by the first block 1002. After finishing the first block, the focused modulated image 1001 is moved back to the initial vertical position then moved horizontally to a second block 1003. Subsequently, the same vertical movement follows.

FIG. 10B shows a printing configuration where a focused modulated image 1001 first moves horizontally to print the layers of all blocks that are at a first vertical position. After completing the layers of the first vertical position, the focused modulated image 1001 is moved back to the original horizontal position and then moved vertically to a second vertical position. Afterwards, the same horizontal movement follows.

If a horizontal movement is performed after and not during an exposure of one area, it is preferred to have a transitional zone 1004 between two adjacent illumination areas to avoid discontinuity in the printed structure as shown in FIG. 10C. In the transitional zone the optical power may have a ramp-shaped profile to ensure smooth transition between adjacent exposure areas. If a horizontal movement is preferred for example smoothening the boundary, a continuous movement is preferred during the exposure.

Two or more of the above embodiments may be combined in any appropriate manner. While in some embodiments the photosensitive material was used which reacts via a photopolymerization reaction, in general each of the embodiments is equally applicable to the use of a photosensitive material which reacts via other types of photochemical reactions.

### CLAUSES

1. A photolithography apparatus for forming a three-dimensional structure inside a three-dimensional volume of photosensitive material configured to activate photochemical reactions according to a predetermined pattern in a layer inside the three-dimensional volume of photosensitive material, comprising:
a stage arranged to hold the volume of photosensitive material;
a light source system arranged to produce an excitation beam, wherein the excitation beam comprises light of a first wavelength, wherein the photochemical reaction inside the volume of photosensitive material is activated by absorption of light of the first wavelength and further arranged to produce a depletion beam, wherein the depletion beam comprises light of a second wavelength, and wherein the photochemical reaction inside the volume of photosensitive material is deactivated by absorption of light of the second wavelength;
a light modulation system arranged to form one or more modulated images using the excitation beam and the depletion beam;
an optical system arranged to focus the one or more modulated images in a focal plane positioned inside the three-dimensional volume of photosensitive material;
wherein the focused one or more modulated images generate the predetermined pattern comprising one or more excitation regions and one or more depletion regions in the focal plane, wherein each excitation region comprises light of the first wavelength and each of the depletion regions comprises light of the second wavelength.
2. The photolithography apparatus according to clause 1, wherein the modulated image is intensity modulated and/or spatially modulated.
3. The photolithography apparatus according to clause 1 or 2, wherein the predetermined pattern comprises a first pattern and a second pattern, the first and second pattern formed by the excitation beam and the depletion beam respectively.
4. The photolithography apparatus according to any of the preceding clauses, wherein within the one or more excitation regions the photochemical reaction of the photosensitive material is activated, while within the one or more depletion regions the photochemical reaction of the photosensitive material is deactivated such that the photochemical reaction in an out-of-focus region is deactivated.
5. The photolithography apparatus according to any of the preceding clauses, wherein absorption of light of the first wavelength by at least part of the photosensitive material activates the photochemical reaction inside the volume of photosensitive material by bringing the at least part of the photosensitive material from a ground state into an excited state and thus producing radicals, while absorption of light of the second wavelength by the photosensitive material deactivates the photochemical reaction inside the volume of photosensitive material by bringing the at least part of the photosensitive material from the excited state back to the ground state, thus depleting radicals.
6. The photolithography apparatus according to any of the preceding clauses, wherein the 3D structure formed is at nano-scale, micro-scale, or macro-scale.
7. The photolithography apparatus according to any of the preceding clauses, wherein the first wavelength is shorter than the second wavelength, preferably wherein the first wavelength is between 350-600 nm and the second wavelength is between 450-800 nm.
8. The photolithography apparatus according to any of the preceding clauses, wherein the photosensitive material is a photoresist or a photopolymer, preferably a photosensitive material that is compatible with stimulated emission depletion (STED) mechanisms or photo-induced deactivation (RAPID) mechanisms.
9. The photolithography apparatus according to clause 8, wherein when a photochemical reaction activates at a particular position within the volume of photosensitive material, the photosensitive material at that particular position changes from soluble to insoluble or from insoluble to soluble during a subsequent chemical development step.
10. The photolithography apparatus according to any of the preceding clauses, wherein a substantial region within the one or more modulated images is focused substantially simultaneously.
11. The photolithography apparatus according to any of the preceding clauses, wherein the stage is arranged to be moveable in a first and a second direction spanning the focal plane and/or moveable in a third direction orthogonal to the focal plane.
12. The photolithography apparatus according to any of the preceding clauses, wherein the stage and/or the optical system is arranged to be able to alter the location of the focal plane within the volume of photosensitive material such that the 3D structure can be formed layer-by-layer within each altered location of the focal plane.
13. The photolithography apparatus according to any of the preceding clauses, wherein the light modulation system comprises a digital micromirror device (DMD), a digital light processing (DLP) chip, a liquid crystal display (LCD), a liquid crystal on silicon (LCOS), a deformable mirror and/or an organic light emitting diode (OLED).
14. The photolithography apparatus according to any of the preceding clauses, wherein the light source system comprises a light source, the light source being a light emitting diode, a superluminescent diode. a laser or an arc lamp.
15. The photolithography apparatus according to clause 13, wherein the light source system comprises a first light source and a second light source, wherein the first light source produces light of the first wavelength and the second light source produces light of the second wavelength.
16. The photolithography apparatus according to any of the preceding clauses, wherein the excitation beam and the depletion beam have respectively a first and second incident angle with respect to the light modulation system, and wherein the light modulation system is configured to use the difference in incident angle to form the modulated image having the predetermined pattern forming a wavelength-modulated image where the one or more excitation and depletion regions are present at the same time,
   preferably wherein the light modulation system comprises a digital micromirror device (DMD) having multiple micromirrors with a first reflection state and a second reflection state and wherein each of the micromirrors in the first reflection state reflects light having the first incident angle towards the three-dimensional volume of photosensitive material and each of the mirrors in the second reflection state reflects light having the second incident angle towards the three-dimensional volume of photosensitive material via the optical system.
17. The photolithography apparatus according to any of clauses 1-16, wherein the excitation beam and the depletion beam have the same incident angle with respect to the light modulation system, and wherein the light modulation system is configured to use the difference in wavelength of the light in the excitation beam and the depletion beam to form the modulated image having the predetermined pattern,
   preferably wherein the light modulation system has modulation elements having a first state and a second state such that light from the excitation beam and the depletion beam is reflected and/or transmitted by the modulation elements in the first state towards the three-dimensional volume of photosensitive material through the periodic color filter, while not reflected and/or transmitted by the modulation elements in the second state towards the three-dimensional volume of photosensitive material.
18. The photolithography apparatus according to any of clauses 1-16, wherein the light modulation system is arranged to form a modulated excitation image having a predetermined excitation pattern using the excitation beam and a modulated depletion image having a predetermined depletion pattern using the depletion beam and wherein the modulated image having the predetermined pattern is formed from the modulated excitation image and the modulated depletion image,
   preferably wherein the light modulation system comprises a first and second digital mirror device, the first digital micromirror device (DMD) arranged to form the modulated excitation image having the predetermined excitation pattern and the second digital micromirror device (DMD) arranged to form the modulated depletion image having the predetermined depletion pattern, and wherein the modulated excitation image and the modulated depletion image are thereafter combined.
19. The photolithography apparatus according to any of clauses 1-16, wherein the excitation beam and the depletion beam have the same incident angle with respect to the light modulation system, and wherein the light modulation system is configured to adapt a focal spot of the depletion beam to have a hollow center such that the one or more excitation regions will be surrounded by depletion regions in the focal plane, preferably wherein the light modulation system comprises a phase plate, more preferably an annular phase plate or vortex phase plate, and wherein the phase plate is arranged to adapt the focal spot of the depletion beam to have a hollow center.
20. The photolithography apparatus according to any of the preceding clauses, wherein the predetermined pattern is based on the section of the 3D structure to be formed in the focal plane.
21. The photolithography apparatus according to any of the preceding clauses, wherein each of the excitation regions and each of the depletion regions have a predefined area.
22. The photolithography apparatus according to clause 21, wherein an excitation region that only falls partially within the boundary of the section of the 3D structure to be formed is exposed during a first exposure period and an excitation region that falls completely within the boundary of the section of the 3D structure to be formed is exposed during a second exposure period, the first exposure period being smaller than the second exposure period.
23. The photolithography apparatus according to clause 21 or 22, wherein an excitation region that only falls partially within the boundary of the section of the 3D structure to be formed is exposed using a first intensity and an excitation region that falls completely within the boundary of the section of the 3D structure to be formed is exposed using a second intensity, the first intensity being less than the second intensity.
24. The photolithography apparatus according to any one of clauses 21-23, wherein the section of the 3D structure to be formed in the focal plane is formed in multiple exposure steps, wherein at each exposure step only a fractional exposure is delivered, and wherein during and/or after each exposure step the stage is moved in a direction parallel or vertical to the focal plane with a displacement smaller than the voxel size of the predefined area of the excitation region in that direction.
25. The photolithography apparatus according to clause 24, wherein the movement of the stage is a continuous movement or a step-by-step movement.
26. The photolithography apparatus according to any of the preceding clauses, wherein the excitation beam further comprises light of a third wavelength to activate a photochemical reaction jointly with the light of the first wavelength.
27. The photolithography apparatus according to clause 26, wherein the third wavelength can be same or different from the first wavelength.
28. A photolithography method to activate photochemical reactions according to a predetermined pattern in a layer inside a three-dimensional volume of photosensitive material in order to form a 3D structure therein, comprising:
   providing the volume of photosensitive material on a stage;
   providing an excitation beam by a light source system, wherein the excitation beam comprises light of a first wavelength, wherein the photochemical reaction inside the volume of photosensitive material is activated by absorption of light of the first wavelength;
   providing a depletion beam by the light source system, wherein the depletion beam comprises light of a second wavelength, and wherein the photochemical reaction inside the volume of photosensitive material is deactivated by absorption of light of the second wavelength;
   forming a modulated image by a light modulation system using the excitation beam and the depletion beam;
   focusing the intensity modulated image by an optical system in a focal plane positioned inside the volume of photosensitive material;
   forming one or more excitation regions and one or more depletion regions in the focal plane using the focused intensity modulated image having the predetermined pattern, wherein each excitation region comprises light of the first wavelength and each of the depletion regions comprises light of the second wavelength.
29. The photolithography method according clause 28, wherein within the one or more excitation regions the photochemical reaction of the photosensitive material is activated, while within the one or more depletion regions the photochemical reaction of the photosensitive material is deactivated such that the photochemical reaction in an out-of-focus region is deactivated,
   preferably wherein absorption of light of the first wavelength by at least part of the photosensitive material activates the photochemical reaction inside the volume of photosensitive material by bringing the at least part of the photosensitive material from a ground state into an excited state and thus producing radicals, while absorption of light of the second wavelength by the photosensitive material deactivates the photochemical reaction inside the volume of photosensitive material by bringing the at least part of the photosensitive material from the excited state back to the ground state, thus depleting radicals.
30. A 3D structure obtained using the photolithography method according to any one of clauses 28-29.

1. A photolithography apparatus for forming a three-dimensional structure inside a three-dimensional volume of photosensitive material configured to activate photochemical reactions according to a predetermined pattern in a layer inside the three-dimensional volume of photosensitive material, comprising:
a stage arranged to hold the volume of photosensitive material;
a light source system arranged to produce an excitation beam, wherein the excitation beam comprises light of a first wavelength, wherein the photochemical reaction inside the volume of photosensitive material is activated by absorption of light of the first wavelength and further arranged to produce a depletion beam, wherein the depletion beam comprises light of a second wavelength, and wherein the photochemical reaction inside the volume of photosensitive material is deactivated by absorption of light of the second wavelength;
a light modulation system arranged to form one or more modulated images using the excitation beam and the depletion beam;
an optical system arranged to combine the excitation beam and the depletion beam into a combined beam, and further arranged to focus the one or more modulated images of the combined beam in a focal plane positioned inside the three-dimensional volume of photosensitive material;
wherein the optical system is arranged such as to focus the one or more modulated images to generate the predetermined pattern in such a way that one or more excitation regions and one or more depletion regions are formed inside the three-dimensional volume of photosensitive material, such that the cross-section between the focal plane and the excitation and depletion regions corresponds to the predetermined pattern,
wherein each excitation region comprises light of the first wavelength and each of the depletion regions comprises light of the second wavelength,
wherein on both sides outside of the focal plane the one or more excitation regions and the one or more depletion regions at least partially overlap so as to bound a reaction volume inside the photosensitive material centered around the focal plane which is activated by the combined beam; and
wherein the lateral and vertical resolution of the obtained reaction volume are controlled by the light source system and the light modulation system by controlling the amount of overlap of the one or more excitation regions and the one or more depletion regions outside the focal plane.

2. The photolithography apparatus of claim 1, wherein the wavelength-dependent absorption of light by the photosensitive material is such that the ratio of the intensities between the excitation beam and the depletion beam throughout the depth of the photosensitive material varies at most by 50%, more preferably 25%, more preferably 10%, most preferably wherein the ratio stays substantially constant.

3. The photolithography apparatus of any one of the preceding claims, wherein the photolithography apparatus is configured to work with photosensitive material having an extinction length such that light of the first and second wavelength can penetrate in the direction of the combined beam throughout the entire three-dimensional volume of photosensitive material, and/or wherein the light of the first wavelength can activate the photochemical reaction at any specific location throughout the entire three-dimensional volume of photosensitive material if the photochemical reaction is not deactivated by the absorption of light of the second wavelength at the specific location.

4. The photolithography apparatus of any preceding claim, wherein the reaction volume is made out of reaction voxels which result from the pattern, and which are each bounded three-dimensionally by one or more depletion regions.

5. The photolithography apparatus of any preceding claim, wherein each excited region is generally bounded by one or more depletion regions.

6. The photolithography apparatus of any preceding claim, wherein the lateral and/or vertical resolution of the reaction volume is controlled by controlling the intensity of the excitation beam and/or the depletion beam.

7. The photolithography apparatus of claim 6, wherein the intensity of the excitation and/or depletion beam is varied within the predetermined pattern based on a desired lateral and vertical resolution and size of patterns and/or wherein the amount in which the cross-section of the excitation region with the focus plane is surrounded by the cross-section of the depletion region with the focus plane is based on a desired lateral and vertical resolution, preferably wherein the intensity and/or the amount of being surrounded is varied locally throughout the pattern.

8. The photolithography apparatus of any of the preceding claims, wherein the excitation beam and the depletion beam are overlapped such that for each excitation region one or more of the depletion regions is formed at a distance equal to the vertical resolution from the focal plane on both sides in the direction of the combined beam.

9. The photolithography apparatus of any of the preceding claims, wherein the photolithography apparatus is configured such that a first reaction voxel and a second reaction voxel resulting from the same combined beam have different vertical resolutions.

10. The photolithography apparatus of any preceding claim, wherein the one or more modulated images are focused by a lens having a numerical aperture, wherein the lateral resolution and/or vertical resolution of a reaction voxel is controlled by the numerical aperture of the lens, preferably wherein the numerical aperture of the lens is greater than 0.5, more preferably 1.0, more preferably 1.2, more preferably 1.4.

11. The photolithography apparatus of any preceding claim, wherein the light source system is further arranged to produce a second excitation beam comprising light of a third wavelength, wherein the second excitation beam is configured to activate the photochemical reaction jointly with the light of the first wavelength.

12. The photolithography apparatus of any preceding claim, wherein the predetermined pattern is any of a checkerboard pattern, an alternating line pattern, a periodically alternating line pattern, an irregular pattern, a concentric pattern.

13. The photolithography apparatus of any preceding claim, wherein the predetermined pattern is complementarily filled by the one or more excitation regions and the one or more depletion region, preferably wherein the one or more excitation regions and the one or more depletion regions are interleaved.

14. The photolithography apparatus of any preceding claim, wherein the excitation region occupies the cross-section of the focal plane with the three-dimensional structure to be formed for less than 50% in one step.

15. The photolithography apparatus of any preceding claim, wherein the excitation beam and the depletion beam are combined before forming the one or more modulated images or wherein the excitation beam and the depletion beam are combined after forming the one or more modulated images.

16. The photolithography apparatus of any preceding claim, wherein components of at least two of the light source system, the light modulation system and/or the optical system are interleaved along the optical path.

17. The photolithography apparatus of any preceding claim, wherein the photolithography apparatus is configured to form the layer of the three-dimensional structure in the focal plane by activating photochemical reactions according to multiple predetermined patterns subsequently in the photosensitive material, wherein the exposure of the photosensitive material to these multiple predetermined patterns, cumulatively forms the layer, preferably such that the reaction volume resulting from each of the multiple predetermined patterns do not overlap spatially, more preferably wherein the vertical resolution improves the more predetermined patterns are used, more preferably to a predetermined amount by utilizing a particular number of predetermined patterns.

18. The photolithography apparatus of claim 18, wherein the vertical resolution of each reaction voxel is controlled by the amount in which each excitation region is surrounded by one or more depletion regions, preferably the periodicity of periodically formed excitation regions.

19. The photolithography apparatus of any preceding claim, wherein the vertical resolution of each reaction voxel is controlled to a predetermined amount by controlling the degree in which each reaction voxel is surrounded in the focal plane by the one or more depletion regions.

20. The photolithography apparatus of claim 19 and claim 17 or 18, wherein the degree in which each reaction voxel is surrounded in the focal plane by the one or more depletion regions can be controlled by the sparseness of the excitation regions of each of the multiple predetermined patterns and/or the intensity of the excitation and depletion beam.

21. The photolithography apparatus of claims 17, 18, 20, wherein the photolithography apparatus switches between the multiple predetermined patterns by using the light modulation system to change the modulated image, by moving at least a part of the optical system, and/or by moving the stage.

22. The photolithography apparatus according to any one of the preceding claims, wherein the modulated image is intensity modulated and/or spatially modulated; and/or
wherein the predetermined pattern comprises a first pattern and a second pattern, the first and second pattern formed by the excitation beam and the depletion beam respectively;
and/or wherein within the one or more excitation regions the photochemical reaction of the photosensitive material is activated, while within the one or more depletion regions the photochemical reaction of the photosensitive material is deactivated such that the photochemical reaction in an out-of-focus region is deactivated.

23. The photolithography apparatus according to any one of the preceding claims, wherein absorption of light of the first wavelength by at least part of the photosensitive material activates the photochemical reaction inside the volume of photosensitive material by bringing the at least part of the photosensitive material from a ground state into an excited state and thus producing radicals, while absorption of light of the second wavelength by the photosensitive material deactivates the photochemical reaction inside the volume of photosensitive material by bringing the at least part of the photosensitive material from the excited state back to the ground state, thus depleting radicals.

24. The photolithography apparatus according to any one of the preceding claims, wherein the 3D structure formed is at nano-scale, micro-scale, or macro-scale;
and/or wherein the first wavelength is shorter than the second wavelength, preferably between 250-1000 nm;
and/or wherein the photosensitive material is a photoresist or a photopolymer, preferably a photosensitive material that is compatible with stimulated emission depletion (STED) mechanism, photo-induced deactivation (RAPID) mechanism, reverse intersystem crossing (RISC), triplet-triplet annihilation (TTA) or two-step absorption (TSA); preferably wherein when a photochemical reaction activates at a particular position within the volume of photosensitive material, the photosensitive material at that particular position changes from soluble to insoluble or from insoluble to soluble during a subsequent chemical development step.

25. The photolithography apparatus according to any one of the preceding claims, wherein a substantial region within the one or more modulated images is focused substantially simultaneously;
and/or wherein the stage is arranged to be moveable in a first and a second direction spanning the focal plane and/or moveable in a third direction orthogonal to the focal plane;
and/or wherein the stage and/or the optical system is arranged to be able to alter the location of the focal plane within the volume of photosensitive material such that the 3D structure can be formed layer-by-layer within each altered location of the focal plane;
and/or wherein the light modulation system comprises a digital micromirror device (DMD), a digital light processing (DLP) chip, a liquid crystal display (LCD), a liquid crystal on silicon (LCOS), a deformable mirror and/or an organic light emitting diode (OLED).

26. The photolithography apparatus according to any one of the preceding claims, wherein the light source system comprises a light source, the light source being a light emitting diode, a superluminescent diode, a laser or an arc lamp; preferably wherein the light source system comprises a first light source and a second light source, wherein the first light source produces light of the first wavelength and the second light source produces light of the second wavelength.

27. The photolithography apparatus according to any one of the preceding claims, wherein the excitation beam and the depletion beam have respectively a first and second incident angle with respect to the light modulation system, and wherein the light modulation system is configured to use the difference in incident angle to form the modulated image having the predetermined pattern forming a wavelength-modulated image where the one or more excitation and depletion regions are present at the same time,
preferably wherein the light modulation system comprises a digital micromirror device (DMD) having multiple micromirrors with a first reflection state and a second reflection state and wherein each of the micromirrors in the first reflection state reflects light having the first incident angle towards the three-dimensional volume of photosensitive material and each of the mirrors in the second reflection state reflects light having the second incident angle towards the three-dimensional volume of photosensitive material via the optical system.

28. The photolithography apparatus according to any one of the preceding claims, wherein the excitation beam and the depletion beam have the same incident angle with respect to the light modulation system, and wherein the light modulation system is configured to use the difference in wavelength of the light in the excitation beam and the depletion beam to form the modulated image having the predetermined pattern,
preferably wherein the light modulation system has modulation elements having a first state and a second state such that light from the excitation beam and the depletion beam is reflected and/or transmitted by the modulation elements in the first state towards the three-dimensional volume of photosensitive material through the periodic color filter, while not reflected and/or transmitted by the modulation elements in the second state towards the three-dimensional volume of photosensitive material.

29. The photolithography apparatus according to any of the preceding claims, wherein the light modulation system is arranged to form a modulated excitation image having a predetermined excitation pattern using the excitation beam and a modulated depletion image having a predetermined depletion pattern using the depletion beam and wherein the modulated image having the predetermined pattern is formed from the modulated excitation image and the modulated depletion image,
preferably wherein the light modulation system comprises a first and second digital mirror device, the first digital micromirror device (DMD) arranged to form the modulated excitation image having the predetermined excitation pattern and the second digital micromirror device (DMD) arranged to form the modulated depletion image having the predetermined depletion pattern, and wherein the modulated excitation image and the modulated depletion image are thereafter combined.

30. The photolithography apparatus according to any of the preceding claims, wherein the excitation beam and the depletion beam have the same incident angle with respect to the light modulation system, and wherein the light modulation system is configured to adapt a focal spot of the depletion beam to have a hollow center such that the one or more excitation regions will be surrounded by depletion regions in the focal plane, preferably wherein the light modulation system comprises a phase plate, more preferably an annular phase plate or vortex phase plate, and wherein the phase plate is arranged to adapt the focal spot of the depletion beam to have a hollow center;
and/or wherein the predetermined pattern is based on the section of the 3D structure to be formed in the focal plane.

31. The photolithography apparatus according to any one of the preceding claims, wherein each of the excitation regions and each of the depletion regions have a predefined area; preferably wherein an excitation region that only falls partially within the boundary of the section of the 3D structure to be formed is exposed during a first exposure period and an excitation region that falls completely within the boundary of the section of the 3D structure to be formed is exposed during a second exposure period, the first exposure period being smaller than the second exposure period.

32. The photolithography apparatus according to claim 31, wherein an excitation region that only falls partially within the boundary of the section of the 3D structure to be formed is exposed using a first intensity and an excitation region that falls completely within the boundary of the section of the 3D structure to be formed is exposed using a second intensity, the first intensity being less than the second intensity;
and/or wherein the section of the 3D structure to be formed in the focal plane is formed in multiple exposure steps, wherein at each exposure step only a fractional exposure is delivered, and wherein during and/or after each exposure step the stage is moved in a direction parallel or vertical to the focal plane with a displacement smaller than the voxel size of the predefined area of the excitation region in that direction; preferably wherein the movement of the stage is a continuous movement or a step-by-step movement;
and/or wherein the excitation beam further comprises light of a third wavelength to activate a photochemical reaction jointly with the light of the first wavelength; preferably wherein the third wavelength can be same or different from the first wavelength.

33. The photolithography apparatus according to any one of the preceding claims, wherein the photolithography apparatus is configured to be able to focus the one or more modulated images of the combined beam in a focal plane at arbitrary depth within the three-dimensional volume of photosensitive material.

34. A photolithography method for forming a three-dimensional structure inside a three-dimensional volume of photosensitive material configured to activate photochemical reactions according to a predetermined pattern in a layer inside the three-dimensional volume of photosensitive material, comprising:
providing the three-dimensional volume of photosensitive material on a stage;
producing an excitation beam, wherein the excitation beam comprises light of a first wavelength, wherein the photochemical reaction inside the volume of photosensitive material is activated by absorption of light of the first wavelength;
producing a depletion beam, wherein the depletion beam comprises light of a second wavelength, and wherein the photochemical reaction inside the volume of photosensitive material is deactivated by absorption of light of the second wavelength;
forming one or more modulated images using the excitation beam and the depletion beam;
combining the excitation beam and the depletion beam into a combined beam;
focusing the one or more modulated images of the combined beam in a focal plane positioned inside the three-dimensional volume of photosensitive material, such as to generate the predetermined pattern in such a way that one or more excitation regions and one or more depletion regions are formed inside the three-dimensional volume of photosensitive material, such that the cross-section between the focal plane and the excitation and depletion regions corresponds to the predetermined pattern;
wherein each excitation region comprises light of the first wavelength and each of the depletion regions comprises light of the second wavelength;
wherein on both sides outside of the focal plane the one or more excitation regions and the one or more depletion regions at least partially overlap so as to bound a reaction volume inside the photosensitive material centered around the focal plane which is activated by the combined beam; and
controlling the lateral and vertical resolution of the obtained reaction volume by controlling the amount of overlap of the one or more excitation regions and the one or more depletion regions outside the focal plane.

35. The photolithography method of claim 34, wherein the photosensitive material has the same absorption coefficient for light of the first and second wavelength.

36. The photolithography method of any one of the preceding claims 34-35, wherein the photosensitive material has an extinction length such that light of the first and second wavelength can penetrate in the direction of the combined beam throughout the entire three-dimensional volume of photosensitive material, and/or wherein the light of the first wavelength can activate the photochemical reaction at any specific location throughout the entire three-dimensional volume of photosensitive material if the photochemical reaction is not deactivated by the absorption of light of the second wavelength at the specific location.

37. The photolithography method of any preceding claims 34-36, wherein the reaction volume is made out of reaction voxels which result from the pattern, and which are each bounded three-dimensionally by one or more depletion regions.

38. The photolithography method of any preceding claims 34-37, wherein each excited region is generally bounded by one or more depletion regions.

39. The photolithography method of any preceding claims 34-38, wherein the lateral and/or vertical resolution of the reaction volume is controlled by controlling the intensity of the excitation beam and/or the depletion beam.

40. The photolithography method of claim 39, wherein the intensity of the excitation and/or depletion beam is varied within the predetermined pattern based on a desired lateral and vertical resolution and size of patterns and/or wherein the amount in which the cross-section of the excitation region with the focus plane is surrounded by the cross-section of the depletion region with the focus plane is based on a desired lateral and vertical resolution, preferably wherein the intensity and/or the amount of being surrounded is varied locally throughout the pattern.

41. The photolithography method of any of the preceding claims 34-40, wherein the excitation beam and the depletion beam are overlapped such that for each excitation region one or more of the depletion regions is formed at a distance equal to the vertical resolution from the focal plane on both sides in the direction of the combined beam.

42. The photolithography method of any of the preceding claims 34-41, wherein a first reaction voxel and a second reaction voxel resulting from the same combined beam have different vertical resolutions.

43. The photolithography method of any preceding claims 34-42, wherein the one or more modulated images are focused by a lens having a numerical aperture, wherein the lateral resolution and/or vertical resolution of a reaction voxel is controlled by the numerical aperture of the lens, preferably wherein the numeral aperture of the lens is greater than 0.5, preferably 0.8, more preferably 1.0, more preferably 1.2, more preferably 1.4.

44. The photolithography method of any preceding claims 34-43, further comprising producing a second excitation beam comprising light of a third wavelength, wherein the second excitation beam is configured to activate the photochemical reaction jointly with the light of the first wavelength.

45. The photolithography method of any preceding claims 34-44, wherein the predetermined pattern is any of a checkerboard pattern, an alternating line pattern, a periodically alternating line pattern, an irregular pattern, a concentric pattern.

46. The photolithography method of any preceding claims 34-45, wherein the predetermined pattern is complementarily filled by the one or more excitation regions and the one or more depletion region, preferably wherein the one or more excitation regions and the one or more depletion regions are interleaved.

47. The photolithography method of any preceding claims 34-46, wherein the focusing step comprises focusing the one or more modulated images of the combined beam in a focal plane at arbitrary depth within the three-dimensional volume of photosensitive material.

48. The photolithography method of any preceding claims 34-47, wherein within the one or more excitation regions the photochemical reaction of the photosensitive material is activated, while within the one or more depletion regions the photochemical reaction of the photosensitive material is deactivated such that the photochemical reaction in an out-of-focus region is deactivated,
preferably wherein absorption of light of the first wavelength by at least part of the photosensitive material activates the photochemical reaction inside the volume of photosensitive material by bringing the at least part of the photosensitive material from a ground state into an excited state and thus producing radicals, while absorption of light of the second wavelength by the photosensitive material deactivates the photochemical reaction inside the volume of photosensitive material by bringing the at least part of the photosensitive material from the excited state back to the ground state, thus depleting radicals.

49. A 3D structure obtained using the photolithography method according to any one of claims 34-48.
